(19) United States
(12) Patent Application Publication
(10) Pub. No.: US 2025/0317558 A1
(43) Pub. Date: Oct. 9, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Na ZHANG, Beijing (CN); Kai ZHANG, Los Angeles, CA (US); Li ZHANG, Los Angeles, CA (US)

(21) Appl. No.: 19/246,523

(22) Filed: Jun. 23, 2025

Related U.S. Application Data
(63) Continuation of application No. PCT/CN2023/141264, filed on Dec. 22, 2023.

(30) Foreign Application Priority Data
Dec. 23, 2022 (WO) PCT/CN2022/141515

(51) Int. Cl. H04N 19/109; H04N 19/176; H04N 19/184; H04N 19/513

(52) U.S. Cl. CPC H04N 19/109; H04N 19/176; H04N 19/184; H04N 19/513

(57) ABSTRACT

Embodiments of the present disclosure provide a solution for video processing. A method for video processing is proposed. In the method, for a conversion between a current video block of a video and a bitstream of the video, a base candidate of the current video block is determined. Whether to inherit a flip type for the base candidate is based on a candidate type of the base candidate. A target candidate of the current video block is determined based on the base candidate. The target candidate includes at least one of: an intra block copy (IBC) merge mode with block vector differences (IBC-MBVD) candidate, an IBC template matching (IBC-TM) merge candidate, or an IBC-TM advanced motion vector prediction (AMVP) candidate. The conversion is performed based on the target candidate.

### CROSS REFERENCE TO RELATED APPLICATIONS

This application is a continuation of International Application No. PCT/CN2023/141264, filed on Dec. 22, 2023, which claims the benefit of International Application No. PCT/CN2022/141515 filed on Dec. 23, 2022. The entire contents of these applications are hereby incorporated by reference in their entireties.

### FIELDS

Embodiments of the present disclosure relates generally to video processing techniques, and more particularly, to intra block copy (IBC) and intra template matching prediction (TMP) mode enhancement.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a base candidate of the current video block, wherein whether to inherit a flip type for the base candidate is based on a candidate type of the base candidate; determining a target candidate of the current video block based on the base candidate, the target candidate comprising at least one of: an intra block copy (IBC) merge mode with block vector differences (IBC-MBVD) candidate, an IBC template matching (IBC-TM) merge candidate, or an IBC-TM advanced motion vector prediction (AMVP) candidate; and performing the conversion based on the target candidate. The method in accordance with the first aspect of the present disclosure enables inheriting the flip type for the base candidate for several coding mode such as reconstruction reordered IBC (RR-IBC) mode, IBC mode or intra TMP mode, etc. In this way, the coding effectiveness and coding efficiency can be improved.

In a second aspect, another method for video processing is proposed. The method comprises: determining, for a conversion between a current video block of a video and a bitstream of the video, a block vector (BV) candidate of the current video block, the BV candidate being associated with a reference block of the current video block; determining a validation of the BV candidate based on at least one reconstructed sample of the reference block and at least one unreconstructed sample of the reference block; and performing the conversion based on the validation of the BV candidate. The method in accordance with the second aspect of the present disclosure determines whether the BV candidate associated with a reference block with at least one unreconstructed sample is valid based on reconstructed samples of the reference block. In this way, a reference block with is not fully reconstructed can be used in several coding modes such as an IBC mode or an intra TMP mode. The coding effectiveness and coding efficiency can thus be improved.

In a third aspect, an apparatus for video processing is proposed. The apparatus comprises a processor and a non-transitory memory with instructions thereon. The instructions upon execution by the processor, cause the processor to perform a method in accordance with the first aspect or the second aspect of the present disclosure.

In a fourth aspect, a non-transitory computer-readable storage medium is proposed. The non-transitory computer-readable storage medium stores instructions that cause a processor to perform a method in accordance with the first aspect or the second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: determining a base candidate of a current video block of the video, wherein whether to inherit a flip type for the base candidate is based on a candidate type of the base candidate; determining a target candidate of the current video block based on the base candidate, the target candidate comprising at least one of: an IBC-MBVD candidate, an IBC-TM merge candidate, or an IBC-TM AMVP candidate; and generating the bitstream based on the target candidate.

In a sixth aspect, a method for storing a bitstream of a video is proposed. The method comprises: determining a base candidate of a current video block of the video, wherein whether to inherit a flip type for the base candidate is based on a candidate type of the base candidate; determining a target candidate of the current video block based on the base candidate, the target candidate comprising at least one of: an IBC-MBVD candidate, an IBC-TM merge candidate, or an IBC-TM AMVP candidate; generating the bitstream based on the target candidate; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: determining a block vector (BV) candidate of a current video block of the video, the BV candidate being associated with a reference block of the current video block; determining a validation of the BV candidate based on at least one reconstructed sample of the reference block and at least one unreconstructed sample of the reference block; and generating the bitstream based on the validation of the BV candidate.

In an eighth aspect, a method for storing a bitstream of a video is proposed. The method comprises: determining a block vector (BV) candidate of a current video block of the video, the BV candidate being associated with a reference block of the current video block; determining a validation of the BV candidate based on at least one reconstructed sample of the reference block and at least one unreconstructed sample of the reference block; generating the bitstream based on the validation of the BV candidate; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates spatial neighboring positions used in IBC vector prediction;

FIG. 5 illustrates current CTU processing order and its available reference samples in current and left CTU;

FIG. 6 illustrates spatial neighboring positions used in IBC merge/AMVP list construction;

FIG. 7 illustrates padding candidates for the replacement of the zero-vector in the IBC list;

FIG. 8 illustrates IBC reference region depending on current CU position;

FIG. 9 illustrates a reference area for IBC when CTU (m, n) is coded;

FIG. 10A illustrates an illustration of BV adjustment for horizontal flip;

FIG. 10B illustrates an illustration of BV adjustment for vertical flip;

FIGS. 11 illustrates an intra template matching search area used;

FIG. 12 illustrates use of IntraTMP block vector for IBC block;

FIG. 13A illustrates an example of IBC block vector candidate list existing only IBC block vectors;

FIG. 13B illustrates an example of IBC block vector candidate list existing both IBC and IntraTMP block vectors;

FIG. 14A to FIG. 14C illustrate the unreconstructed sample in the reference block is estimated by its prediction sample and the samples filled with diagonal stripes are derived sample values for the unreconstructed samples in the reference block, respectively;

FIG. 15A to FIG. 15D illustrate the unreconstructed sample in the reference block is derived by horizontal or vertical padding and the samples filled with diagonal stripes are derived sample values for the unreconstructed samples in the reference block, respectively;

FIG. 16 illustrates horizontal flip, current template is the left column and the top row of current block, reference template is the right column and the top row of reference block, the unreconstructed sample in the reference template is derived by horizontal padding or its prediction sample and the samples filled with diagonal stripes are derived sample values for the unreconstructed samples in the reference template;

FIG. 17 illustrates vertical flip. current template is the left column and the top row of current block, reference template is the left column and the bottom row of reference block, the unreconstructed sample in the reference template is derived by vertical padding or its prediction sample and the samples filled with diagonal stripes are derived sample values for the unreconstructed samples in the reference template;

FIG. 18 illustrates a flowchart of a method for video processing in accordance with embodiments of the present disclosure;

FIG. 19 illustrates a flowchart of a method for video processing in accordance with embodiments of the present disclosure;

FIG. 20 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well. unless the context clearly indicates otherwise. It will be further understood that the terms “comprises”, “comprising”, “has”, “having”, “includes” and/or “including”, when used herein, specify the presence of stated features, elements, and/or components etc. . . . but do not preclude the presence or addition of one or more other features, elements, components and/or combinations thereof.

### Example Environment

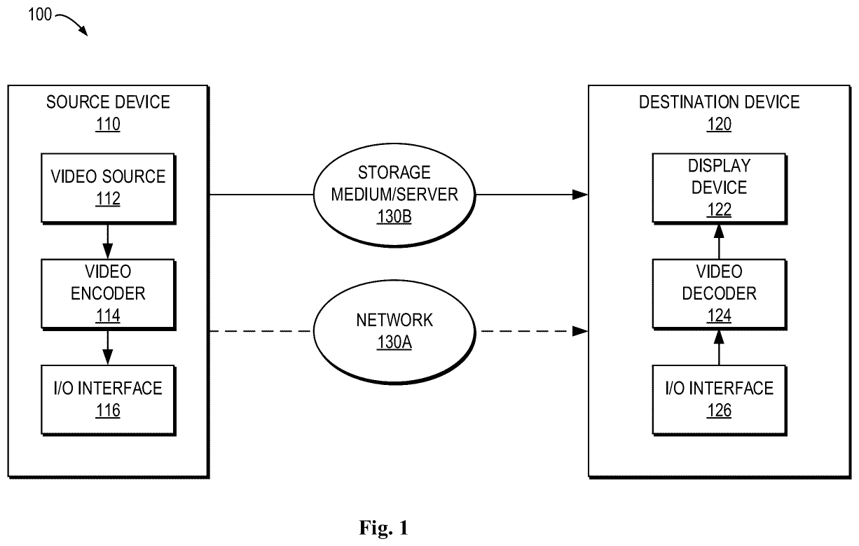

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device. and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard. Versatile Video Coding (VVC) standard and other current and/or further standards.

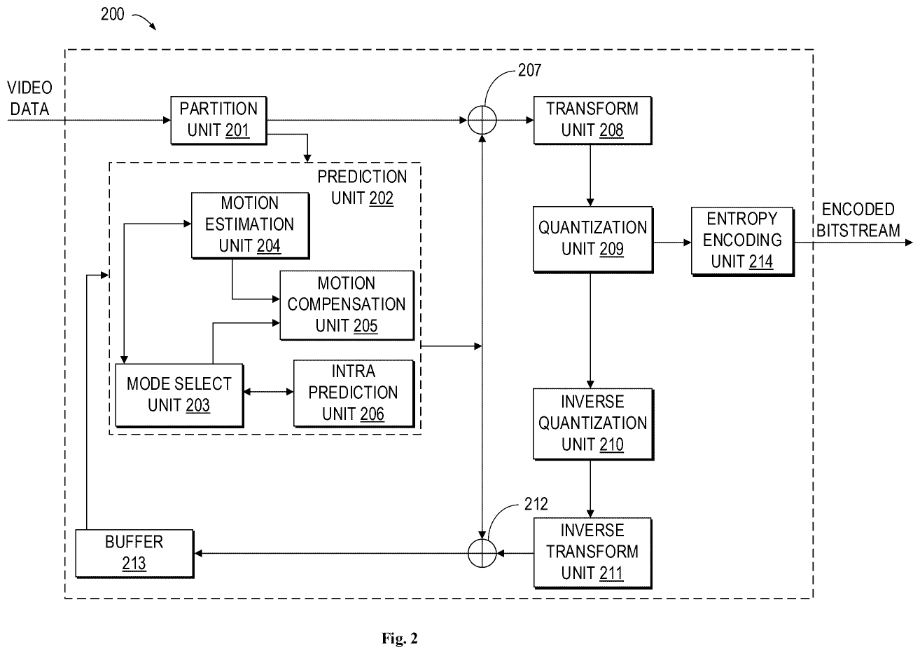

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more. fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects. “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above. video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

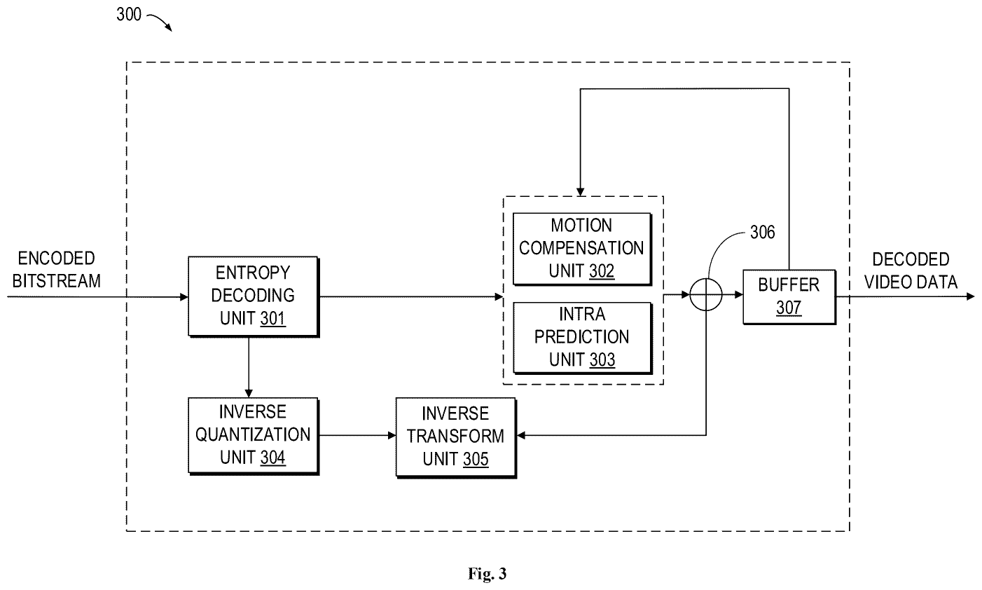

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore. while certain embodiments are described with reference to Versatile Video Coding or other specific video codecs, the disclosed techniques are applicable to other video coding technologies also. Furthermore. while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to image/video coding, especially on IBC and Intra TMP prediction. It may be applied to the existing video coding standard like HEVC, or the standard VVC (Versatile Video Coding). It may be also applicable to future video coding standards or video codec.

### 2. Introduction

Video coding standards have evolved primarily through the development of the well-known ITU-T and ISO/IEC standards. The ITU-T produced H.261 and H.263. ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized.

To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

In January 2021, JVET established an Exploration Experiment (EE), targeting at enhanced compression efficiency beyond VVC capability with novel traditional algorithms. Soon later. ECM was built as the common software base for longer-term exploration work towards the next generation video coding standard.

### 2.1. Intra block copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR. the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.1.1. Simplification of IBC Vector Prediction

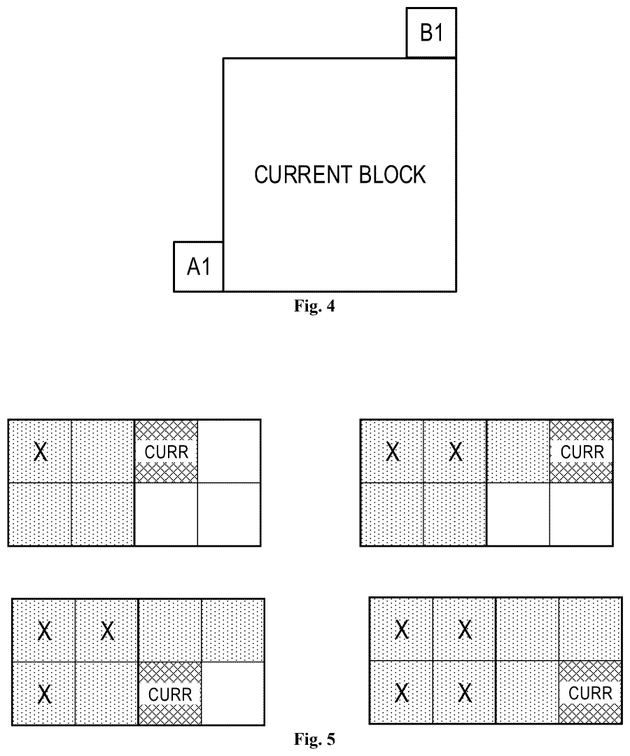

The BV predictors for merge mode and AMVP mode in IBC will share a common predictor list, which consist of the following elements:
2 spatial neighboring positions (A1, B1 as in FIG. 4, which illustrates the spatial neighboring positions used in IBC vector prediction),
5 HMVP entries,
Zero vectors by default.

For merge mode, up to first 6 entries of this list will be used: for AMVP mode, the first 2 entries of this list will be used. And the list conforms with the shared merge list region requirement (shared the same list within the SMR).

### 2.1.2. IBC Reference Region

To reduce memory consumption and decoder complexity, the IBC in VVC allows only the reconstructed portion of the predefined area including the region of current CTU and some region of the left CTU. FIG. 5 illustrates the reference region of IBC Mode, where each block represents 64×64 luma sample unit. FIG. 5 illustrates current CTU processing order and its available reference samples in current and left CTU.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

2.1.3. IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history-based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min (ctbSize, 64) in each dimension, Wᵥ=min (ctbSize, 64).

The virtual IBC buffer, ibcBuf is maintained as follows.

| | |
|---|---|
| - | At the beginning of decoding each CTU row, refresh the whole ibcBuf with an invalid value −1. |
| - | At the beginning of decoding a VPDU (xVPDU, yVPDU) relative to the top-left corner of the picture, |
| | set the ibcBuf[ x ][ y ] =−1, with x = xVPDU%wIbcBuf, ..., xVPDU% wIbcBuf + Wᵥ − 1; y = |
| | yVPDU%ctbSize, ..., yVPDU%ctbSize + Wᵥ − 1. |
| - | After decoding a CU contains (x, y) relative to the top-left corner of the picture, set |
| | ibcBuf[ x % wIbcBuf ][ y % ctbSize ] = recSample[ x ][ y ]. |

For a block covering the coordinates (x, y), if the following is true for a block vector bv = (bv[0], bv[1]), then
it is valid; otherwise, it is not valid:

$$ibcBuf [ ( x + bv [ 0 ] ) \% wIbcBuf ] [ ( y + bv [ 1 ] ) \% ctbSize ] shall not be equal to - 1.$$

### 2.1.4. Ibc Virtual Buffer Test

A luma block vector bvL (the luma block vector in 1/16 fractional-sample accuracy) shall obey the following constraints:

| | |
|---|---|
| - | CtbSizeY is greater than or equal to ( ( yCb + ( bvL[ 1 ] >> 4 ) ) & ( CtbSizeY − 1 ) ) + cbHeight. |
| - | IbcVirBuf[ 0 ][ ( x + (bvL[ 0 ] >> 4 ) ) & ( IbcBufWidthY − 1 ) ][ ( y + (bvL[ 1 ] >> 4 ) ) & ( CtbSizeY |
| | − 1 ) ] shall not be equal to −1 for x = xCb..xCb + cbWidth − 1 and y = yCb..yCb + cbHeight − 1. |

Otherwise, bvL is considered as an invalid bv.

The samples are processed in units of CTBs. The array size for each luma CTB in both width and height is CtbSize Y in units of samples.
(xCb, yCb) is a luma location of the top-left sample of the current luma coding block relative to the top-left luma sample of the current picture,
cbWidth specifies the width of the current coding block in luma samples,
cbHeight specifies the height of the current coding block in luma samples.

### 2.2. IBC Merge/AMVP List Construction

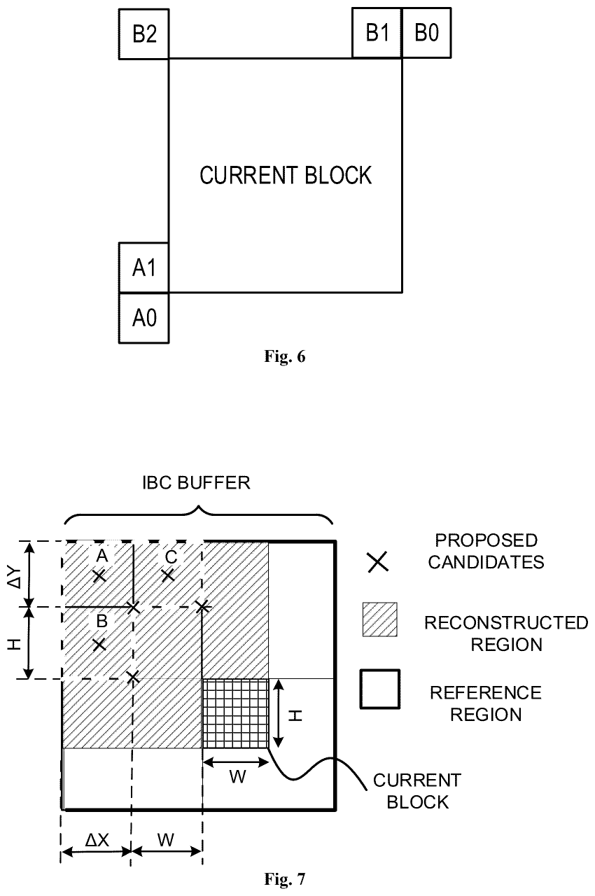

The IBC merge/AMVP list construction is modified as follows:
Only if an IBC merge/AMVP candidate is valid, it can be inserted into the IBC merge/AMVP candidate list.
Above-right, bottom-left, and above-left spatial candidates (B0, A0, and B2 as shown in FIG. 6, which illustrates spatial neighboring positions used in IBC merge/AMVP list construction), and one pairwise average candidate can be added into the IBC merge/AMVP candidate list.
Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 7, which illustrates padding candidates for the replacement of the zero-vector in the IBC list.

### 2.3. IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0). top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

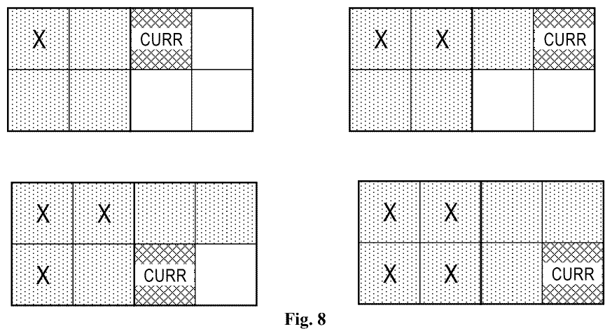

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual. The Template Matching refinement for both IBC-TM merge and AMVP modes is quite simple since IBC motion vectors are constrained (i) to be integer and (ii) within a reference region as shown in FIG. 8, which illustrates IBC reference region depending on current CU position. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### 2.4. IBC Reference Area

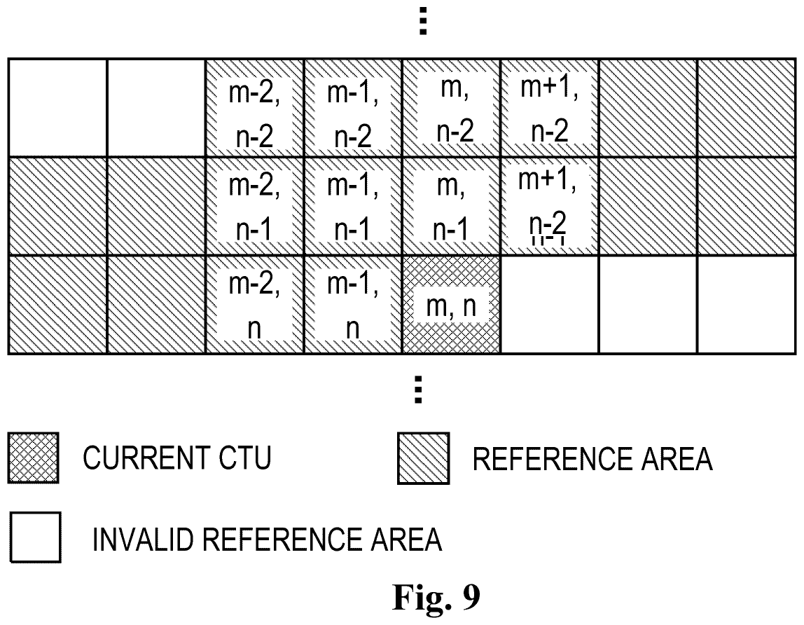

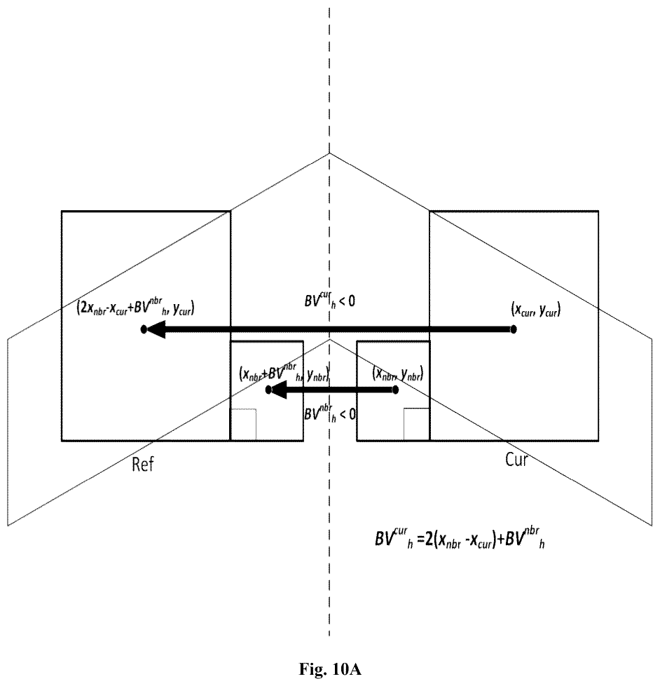

The reference area for IBC is extended to two CTU rows above. FIG. 9 illustrates the reference area for coding CTU (m,n). Specifically, for CTU (m,n) to be coded, the reference area includes CTUs with index (m−2,n−2) . . . (W,n−2). (0,n−1) . . . (W,n−1). (0,n) . . . (m,n), where W denotes the maximum horizontal index within the current tile, slice or picture. When CTU size is 256, the reference area is limited to one CTU row above. This setting ensures that for CTU size being 128 or 256. IBC does not require extra memory in the current ETM platform. The per-sample block vector search (or called local search) range is limited to [−(C<<1). C>>2] horizontally and [−C, C>>2] vertically to adapt to the reference area extension, where C denotes the CTU size.

### 2.5. Reconstruction-Reordered IBC (RR-IBC)

A Reconstruction-Rcordered IBC (RR-IBC) mode is allowed for IBC coded blocks. When RR-IBC is applied. the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

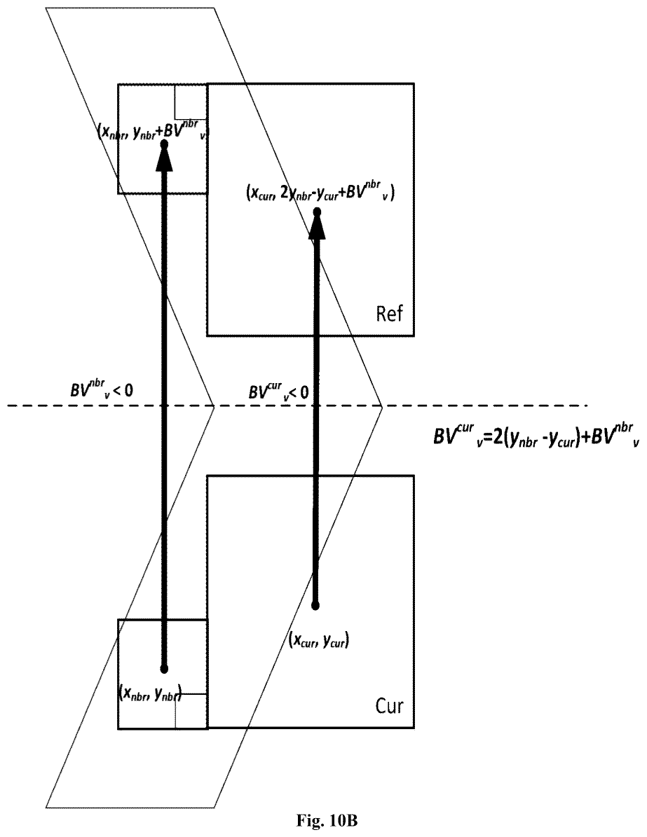

FIG. 10A illustrates an illustration of BV adjustment for horizontal flip. FIG. 10B illustrates an illustration of BV adjustment for vertical flip.

To better utilize the symmetry property, a flip-aware BV adjustment approach is applied to refine the block vector candidate. For example, as shown in FIG. 10A and FIG. 10B. (x_{nbr}, y_{nbr}) and (x_{cur}, y_{cur}) represent the coordinates of the center sample of the neighbouring block and the current block, respectively, BV^{nbr} and BV^{cur} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₙ) in case that the neighbouring block is coded with a horizontal flip, i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr} ₕ) in case that the neighbouring block is coded with a vertical flip, i.e., BV^{cur}ᵥ=2(y_{nbr}'y_{cur})+BV^{nbr}ᵥ.

### 2.6. IBC Merge Mode with Block Vector Differences (IBC-MBVD)

Affine-MMVD and GPM-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel. 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbor block.

### 2.7. Intra Template Matching

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

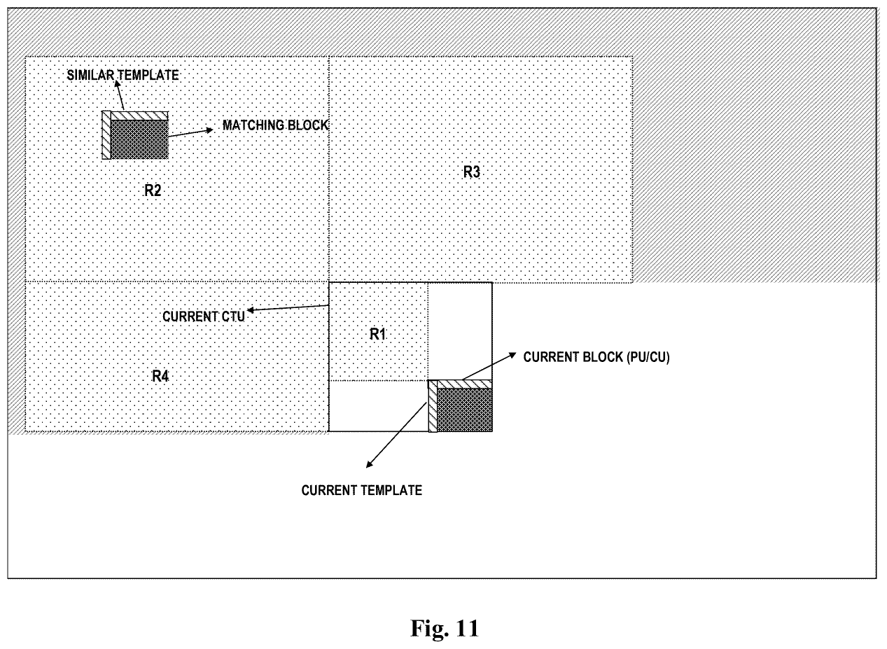

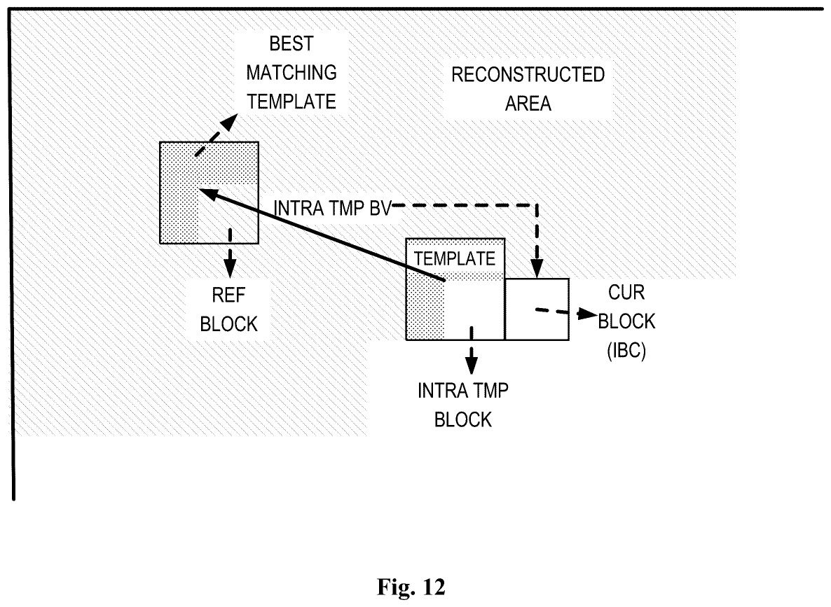

FIG. 11 illustrates an intra template matching search area used. The prediction signal is generated by matching the L-shaped causal neighbor of the current block with another block in a predefined search area in FIG. 11 consisting of:
R1: current CTU,
R2: top-left CTU,
R3: above CTU,
R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$\begin{matrix}SearchRange\_w = a * BlkW , \\ SearchRange\_h = a * BlkH .\end{matrix}$$

Where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.8. Using Block Vector Derived from IntraTMP for IBC

Using block vector derived from IntraTMP for IBC was proposed. The proposed method is to store IntraTMP block vector in the IBC block vector buffer and, the current IBC block can use both IBC BV and IntraTMP BV of neighbouring blocks as BV candidate for IBC BV candidate list as shown in FIG. 12, which illustrates use of IntraTMP block vector for IBC block.

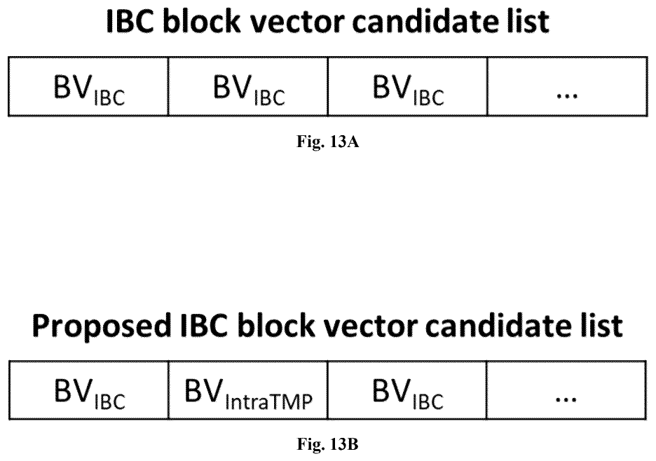

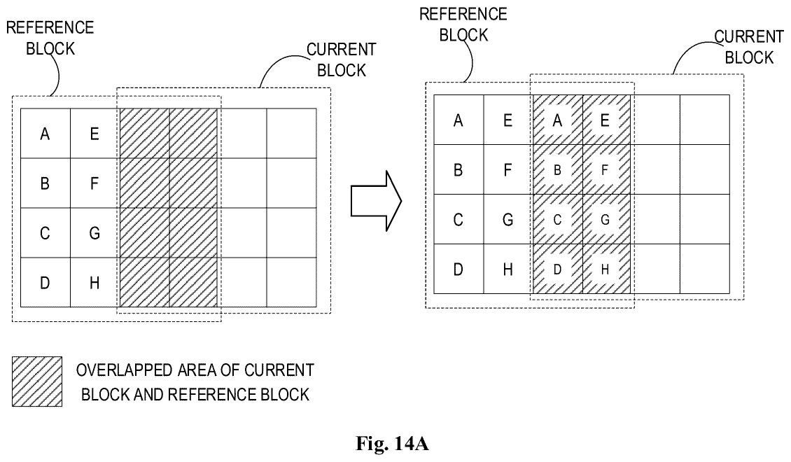

FIG. 13A and FIG. 13B show examples of comparing the block vector candidates which are from only IBC coded neighbouring blocks in the IBC block vector candidate list and the block vector candidates which are from both IBC and IntraTMP coded neighbouring blocks in the proposed IBC block vector candidate list. The IntraTMP block vectors are added to IBC block vector candidate list as spatial candidates.

FIG. 13A illustrates an example of IBC block vector candidate list existing only IBC block vectors. FIG. 13B illustrates an example of IBC block vector candidate list existing both IBC and IntraTMP block vectors. It is noted that the proposed method makes IBC block vector prediction more efficient by using diverse block vectors without additional memory for storing block vectors.

### 3. Problems

In IBC and Intra TMP mode, the samples in the reference block must have been totally reconstructed. Thus, the reference block cannot be overlapped with the current block.

However, the constraint can be removed in some extent. An unreconstructed sample in the reference block can be estimated by its prediction sample.

### 4. Detailed solutions

The detailed embodiments below should be considered as examples to explain general concepts. These embodiments should not be interpreted in a narrow way. Furthermore, these embodiments can be combined in any manner.

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

W and H are the width and height of current block (e.g., luma block).

For an IBC and Intra TMP coded block, a block vector (BV) is used to indicate the displacement from the current block to a reference block, which is already or partially reconstructed inside the current picture.

In the following, a BV candidate is a BV predictor or a searching point.

### Extended IBC and Intra TMP Reference Region

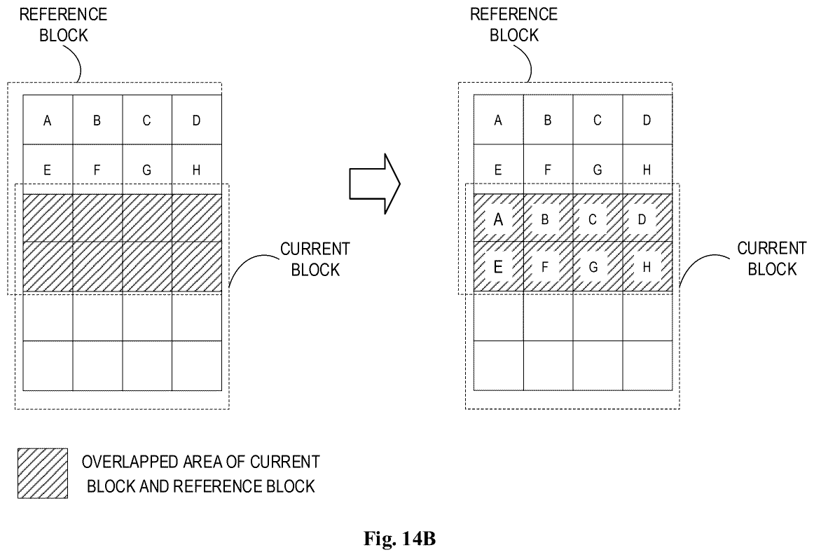

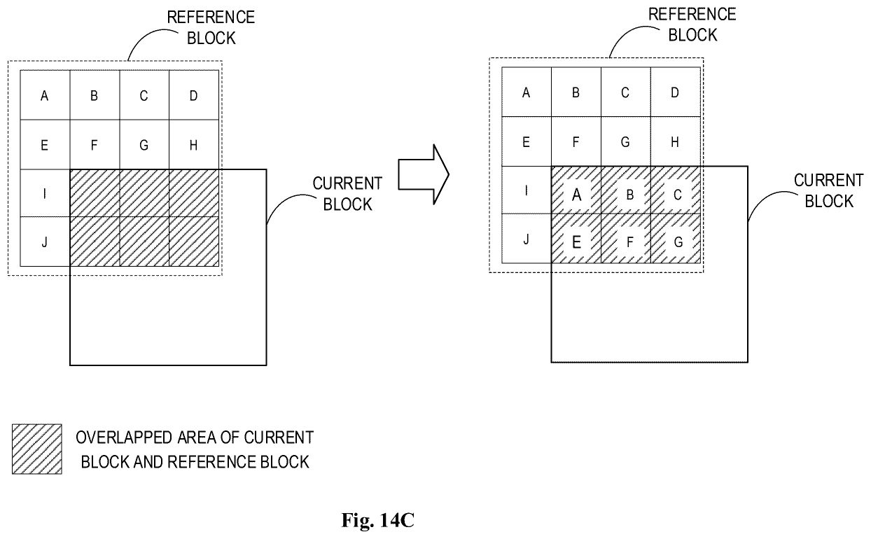

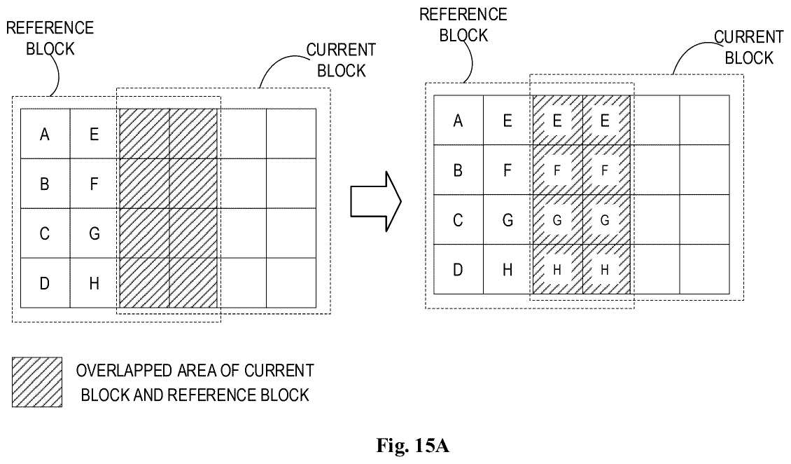

1. A BV candidate may be determined to be valid when at least one sample of the reference block has not been reconstructed before the current block with dimensions BW×BH being reconstructed, inside the current video unit (such as picture, slice, tile, sub-picture, coding unit, etc.).
a. In one example, the BV candidate may be in one of the following coding modes.
   (a) In one example, the coding mode may be regular IBC AMVP mode.
      1) In one example, the BV candidate may be an IBC AMVP candidate, an IBC hash-based searching point, or an IBC block matching based local searching point.
   (b) In one example, the coding mode may be regular IBC merge mode.
      1) In one example, the BV candidate may be an IBC merge candidate.
   (c) In one example, the coding mode may be IBC-TM AMVP mode.
      1) In one example, the BV candidate may be an IBC-TM AMVP candidate, an IBC-TM AMVP refined candidate during the template matching process, an IBC hash-based searching point, or an IBC block matching based local searching point.
   (d) In one example, the coding mode may be IBC-TM merge mode.
      1) In one example, the BV candidate may be an IBC-TM merge candidate or an IBC-TM merge refined candidate during the template matching process.
   (e) In one example, the coding mode may be IBC-MBVD mode.
1) In one example, the BV candidate may be a base BV candidate or a MBVD candidate (i.e., a base BV candidate plus a BVD).
   (f) In one example, the coding mode may be RR-IBC AMVP mode.
      1) In one example, the BV candidate may be a RR-IBC AMVP candidate, a RR-IBC hash-based searching point, or a RR-IBC block matching based local searching point.
   (g) In one example, the coding mode may be RR-IBC merge mode.
      1) In one example, the BV candidate may be a RR-IBC merge candidate.
   (h) In one example, the coding mode may be Intra TMP mode.
      1) In one example, the BV candidate may be an Intra TMP searching point.
b. In one example, an unreconstructed sample in the reference block may be estimated using at least one prediction sample (several examples are shown in FIG. 14A to FIG. 14C).
   (a) In one example, the block vector may satisfy all or some of the following conditions.
      1) The horizontal BV component may be smaller than or equal to 0.
      2) The vertical BV component may be smaller than or equal to 0.
      3) The horizontal BV component may be larger than negative BW (−BW).
      4) The vertical BV component may be larger than negative BH (−BH).
      5) The block vector is nonzero vector.
      6) The reference sample in the right bottom position of the reference block may be not reconstructed.
   (b) In one example, the block vector may need to satisfy at least one of the following conditions.
      1) The horizontal BV component may be smaller than or equal to 0.
      2) The vertical BV component may be smaller than or equal to 0.
      3) The horizontal BV component may be larger than −BW.
      4) The vertical BV component may be larger than −BH.
      5) The block vector is nonzero vector.
      6) The reference sample in the right bottom position of the reference block may be not reconstructed.
   (c) In one example, when deriving the prediction samples of current block, two steps are performed as the following.
      1) 1^{st} step: Derive prediction samples of current block corresponding to the available reconstructed samples in the reference block.

2) 2^{nd} step: Derive the remaining part of the prediction samples P′ (x, y) of current block, corresponding to the unreconstructed samples in the reference block, with

$$P ’ ( x , y ) = P ( x + xPred , y + yPred )$$

wherein the P is the prediction of current block generated in the first step, (x,y) is one sample location in the remaining part of current block, (xPred,yPred) is the BV of current block.
3) In one example, the derivation method for prediction samples may be applied for IBC coded block and/or Intra TMP coded block.
4) In one example, the derivation method for prediction samples may be applied for at least one of IBC coded block and Intra TMP coded block.
5) In one example, the derivation method for prediction samples may be applied for non-RR-IBC coded block (i.e., rribcFlipType is 0).
(d) In one example, the derivation method for the unreconstructed sample in the reference block may be applied for IBC coded block and Intra TMP coded block.
(e) In one example, the derivation method for the unreconstructed sample in the reference block may be applied for at least one of IBC coded block and Intra TMP coded block.
(f) In one example, the derivation method for the unreconstructed sample in the reference block may be applied for non-RR-IBC coded block (i.e., rribcFlipType is 0).

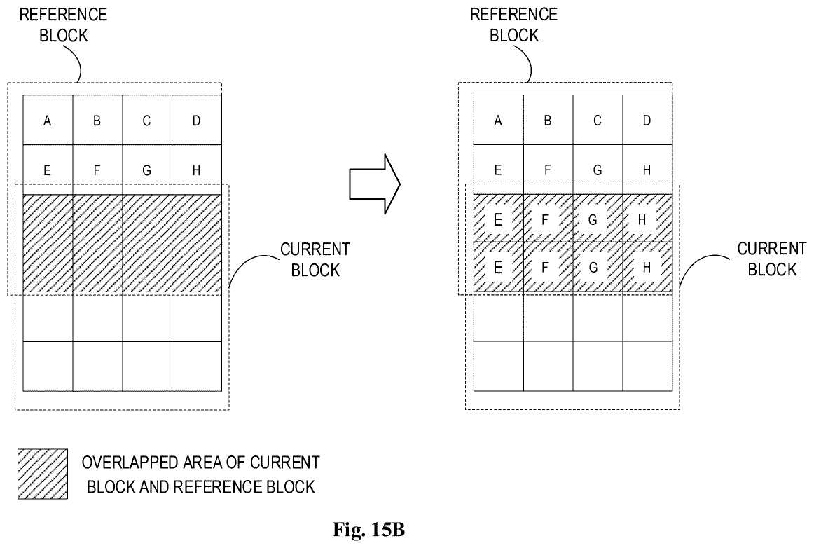

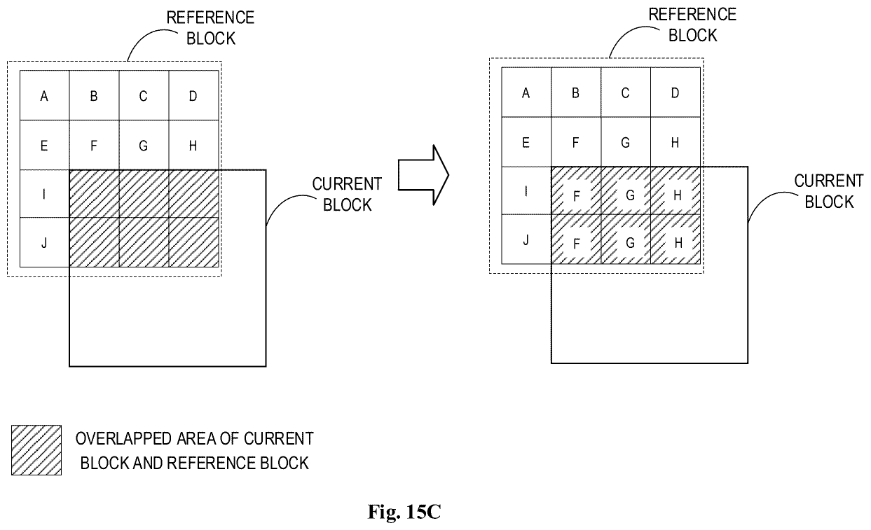

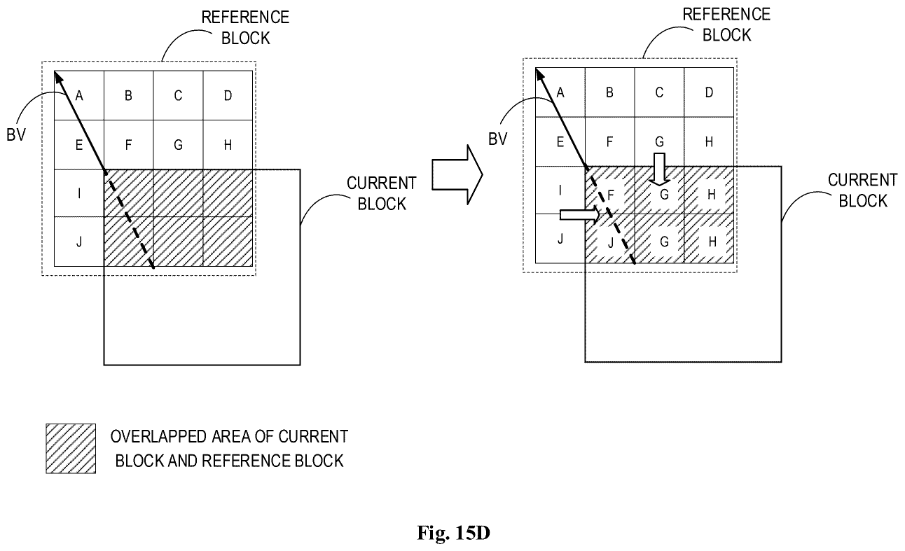

FIG. 14A to FIG. 14C illustrate the unreconstructed sample in the reference block is estimated by its prediction sample and the samples filled with diagonal stripes are derived sample values for the unreconstructed samples in the reference block, respectively. Particularly, in FIG. 14A, the BV candidate is a horizontal directional BV. In FIG. 14B, the BV candidate is a vertical directional BV. In FIG. 14C, the BV candidate is a BV with non-zero vertical component and non-zero horizontal component.
c. In one example, an unreconstructed sample in the reference block may be derived by horizontal or vertical padding (several examples are shown in FIG. 15A to FIG. 15D).
   (a) In one example, the unreconstructed sample in the reference block may be derived by horizontal padding.
   (b) In one example, the unreconstructed sample in the reference block may be derived by vertical padding.
   (c) In one example, the unreconstructed samples in the reference block may be derived by horizontal and/or vertical padding using BV to derive the boundary.
      1) In this method, extend the BV of current block along the same line towards the overlapped area and split the overlapped area into two regions. The reference samples in the bottom-left overlapped region are generated by copying the reference samples of the right-most column of the left CU (horizontal padding), and the reference samples in the top-right region are generated by copying the reference samples of the bottom-most row of the above CU (vertical padding).
   (d) In one example, the unreconstructed sample in the reference block may be padded horizontally if the height of the unavailable part is larger than the width of the unavailable part.
   (e) In one example, the unreconstructed sample in the reference block may be padded vertically if the width of the unavailable part is larger than the height of the unavailable part.
   (f) In one example, the unreconstructed sample in the reference block may be derived by horizontal padding if the BV is horizontal (i.e., BV has nonzero horizontal component and has zero vertical component).
   (g) In one example, the unreconstructed sample in the reference block may be derived by vertical padding if the BV is vertical (i.e., BV has zero horizontal component and has nonzero vertical component).
   (h) In one example, the derivation method for the unreconstructed sample in the reference block may be applied for IBC coded block and Intra TMP coded block.
   (i) In one example, the derivation method for the unreconstructed sample in the reference block may be applied for at least one of IBC coded block and Intra TMP coded block.
   (j) In one example, the derivation method for the unreconstructed sample in the reference block may be only applied for RR-IBC coded block (i.e., rribcFlip Type is 1 or 2).

FIG. 15A to FIG. 15D illustrate the unreconstructed sample in the reference block is derived by horizontal or vertical padding and the samples filled with diagonal stripes are derived sample values for the unreconstructed samples in the reference block, respectively. In FIG. 15A, the BV candidate is a horizontal directional BV, and horizontal padding may be applied. In FIG. 15B, the BV candidate is a vertical directional BV, and vertical padding may be applied. In FIG. 15C, the BV candidate is a BV with non-zero vertical component and non-zero horizontal component, and vertical padding may be applied. In FIG. 15D, the BV candidate is a BV with non-zero vertical component and non-zero horizontal component, and horizontal and vertical padding using BV as boundary may be applied.

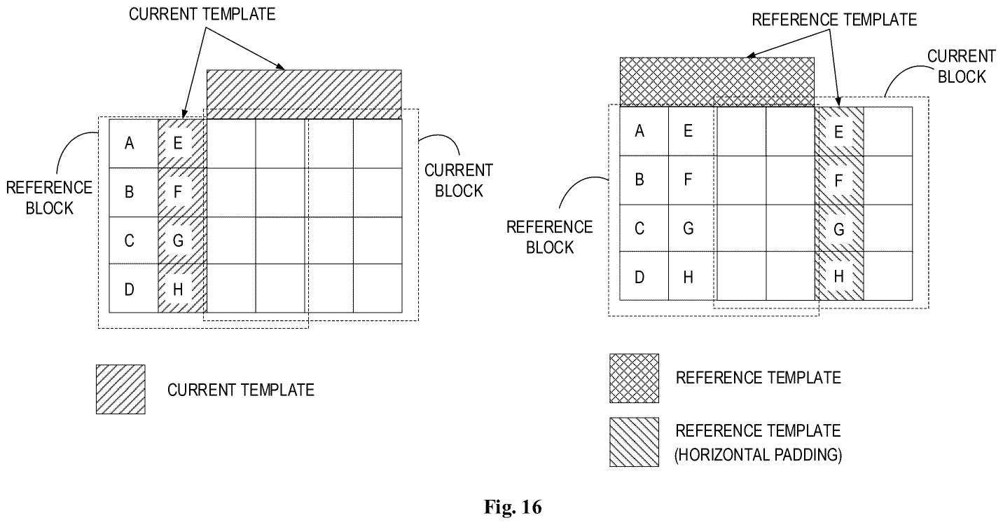

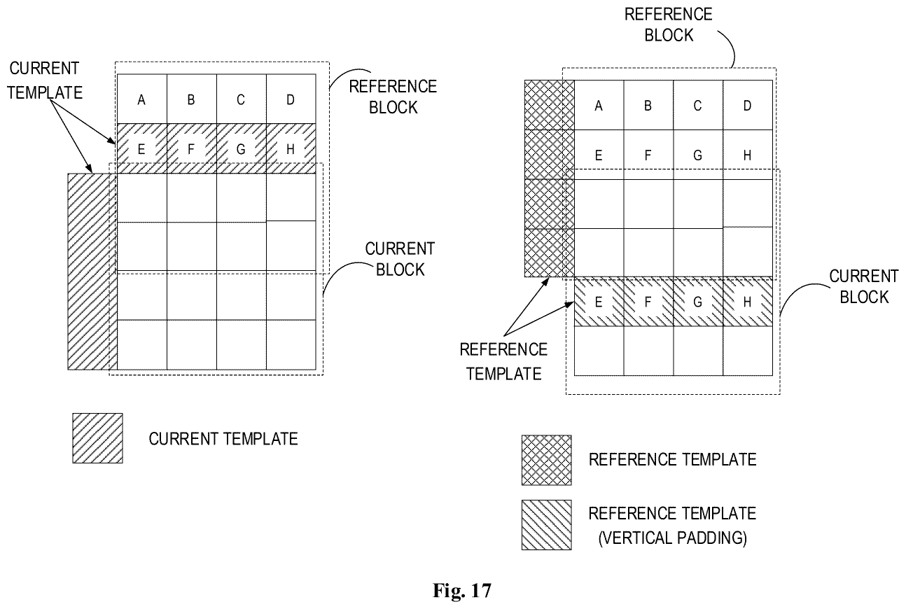

2. The template matching process for a BV candidate (bvCand_{Part}) whose corresponding reference block is partially reconstructed inside the current picture may be different from the template matching process for a BV candidate (bvCand_{Total}) whose corresponding reference block is totally reconstructed inside the current picture.
a. In one example, the template matching process may be template matching based reordering.
b. In one example, the template matching process may be template matching based refinement.
c. In one example, a reference sample of current template may be padded if the corresponding reference sample has not been reconstructed.
   (a) In one example, same/similar padding method disclosed in bullet 1 may be applied to pad the reference sample of current template.
   (b) In one example, a reference sample of current template may need to be padded if current block is horizonally flipped.
      1) In one example, the right column part of reference template may be derived by horizontal padding or its prediction samples as shown in FIG. 16. FIG. 16 illustrates horizontal flip, current template is the left column and the top row of current block, reference template is the right column and the top row of reference block, the unreconstructed sample in the reference template is derived by horizontal padding or its prediction sample and the samples filled with diagonal stripes are derived sample values for the unreconstructed samples in the reference template.
   (c) In one example, a reference sample of current template may need to be padded if current block is vertically flipped.
      1) In one example, the bottom row part of reference template may be derived by vertical padding or its prediction samples as shown in FIG. 17. FIG. 17 illustrates vertical flip, current template is the left column and the top row of current block, reference template is the left column and the bottom row of reference block, the unreconstructed sample in the reference template is derived by vertical padding or its prediction sample and the samples filled with diagonal stripes are derived sample values for the unreconstructed samples in the reference template.
d. In one example, the template matching cost of bvCand_{Part} between current template and reference template may be modified.
   (a) In one example, the cost C may be multiplied by a factor.
   (b) In one example, the factor may be larger than one.
      1) In one example, the factor may be 2.5.
      2) In one example, the factor may be 3.
      3) In one example, the factor may be 3.5.
   (c) In one example, the factor may be different for different overlapping ratios.
      1) In one example, the factor may become larger with the overlapping ratio become larger.
      2) In one example, the first factor of a first bvCand_{Part} may be larger than or equal to the second factor of a second bvCand_{Part} when the overlapping ratio of a first bvCand_{Part} is larger than or equal to the overlapping ratio of a second bvCand_{Part}.
      3) In one example, the overlapping ratio may be the area of the unavailable part divided by the area of current block.
   (d) In one example, the factor may be different for different coding configurations.
   (e) In one example, the factor may be different for different sequence resolutions.
   (f) In one example, the factor may be an integer.
   (g) In one example, the modified C denoted as C′ may be derived as f (C), where f is a function.

$$\begin{matrix}1 ) For example , C ’ = 3 * C + R i g h t S h i f t ( C , 1 ) . \\ 2 ) For example , C ’ = 2 * C + R i g h t S h i f t ( C , 1 ) . \\ 3 ) For example , C ’ = 4 * C + R i g h t S h i f t ( C , 1 ) . \\ 4 ) For example , C ’ = 1 * C + R i g h t S h i f t ( C , 1 ) . \\ 5 ) For example , C ’ = 3 * C . \\ 6 ) For example , C ’ = 2 * C . \\ 7 ) For example , C ’ = 4 * C .\end{matrix}$$

### Reconstruction-Reordered IBC (RR-IBC)

3. The flip type of a pairwise average candidate may be set as
a. In one example, the flip type of a pairwise average candidate may be set to 0.
b. In one example, if a first candidate and a second candidate to derive a pairwise average candidate have the same flip type, set the same flip type as the flip type of the pairwise average candidate; otherwise, set 0 as the flip type of a pairwise average candidate.
c. In one example, if a first candidate and a second candidate is used to derive a pairwise average candidate, set the flip type of the first candidate as the flip type of the pairwise average candidate.
   (a) In one example, the first candidate may be before the second candidate in the BV candidate list.
      1) In one example, the BV candidate list may be regular IBC merge candidate list.
      2) In one example, the BV candidate list may be regular IBC AMVP candidate list.
      3) In one example, the BV candidate list may be IBC-TM merge candidate list.
      4) In one example, the BV candidate list may be IBC-TM AMVP candidate list.
      5) In one example, the BV candidate list may be IBC-MBVD base merge candidate list.

4. Whether to inherit the flip type when deriving the base candidates for IBC-MBVD or IBC-TM merge/AMVP may depend on the candidate type of the base candidates.
a. In one example, HMVP candidates may inherit the flip type when deriving the base candidates for IBC-MBVD or IBC-TM merge/AMVP.
   (a) In one example, a flip-aware BV adjustment approach may be applied to refine the BV candidate.
   (b) In one example, a flip-aware BV adjustment approach may be not applied to refine the BV candidate.
b. In one example, spatial candidates may not inherit the flip type (i.e., rribcFlipType is 0) when deriving the base candidates for IBC-MBVD or IBC-TM merge/AMVP.
c. In one example, temporal candidates may not inherit the flip type (i.e., rribcFlipType is 0) when deriving the base candidates for IBC-MBVD or IBC-TM merge/AMVP.
d. In one example, pairwise candidates may not inherit the flip type (i.e., rribcFlipType is 0) when deriving the base candidates for IBC-MBVD or IBC-TM merge/AMVP.
e. In one example, pairwise candidates may be set as bullet 3 when deriving the base candidates for IBC-MBVD or IBC-TM merge/AMVP.
5. Whether to do flip-aware BV adjustment when deriving the BV candidates may depend on the coding mode.
   a. In one example, when deriving the regular IBC merge candidate, a flip-aware BV adjustment may be performed according to the flip type.
   b. In one example, when deriving the regular IBC AMVP candidate, a flip-aware BV adjustment may be performed according to the flip type.
      (a) Alternatively, when deriving the regular IBC AMVP candidate, a flip-aware BV adjustment may be not performed.
   c. In one example, when deriving the IBC-TM merge candidate, a flip-aware BV adjustment may be not performed.
   d. In one example, when deriving the IBC-TM AMVP candidate, a flip-aware BV adjustment may be not performed.
   e. In one example, when deriving the IBC-MBVD base merge candidate, a flip-aware BV adjustment may be not performed.

6. In above examples, the video unit may refer to the color component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.

7. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

8. Whether to and/or how to apply the disclosed methods above may be signalled at PB/TB/CB/PU/TU/CU/VPDU/CTU/CTU row/slice/tile/sub-picture/other kinds of region contains more than one sample or pixel.

9. Whether to and/or how to apply the disclosed methods above may be dependent on coded information. such as block size, color format, single/dual tree partitioning, color component, slice/picture type.

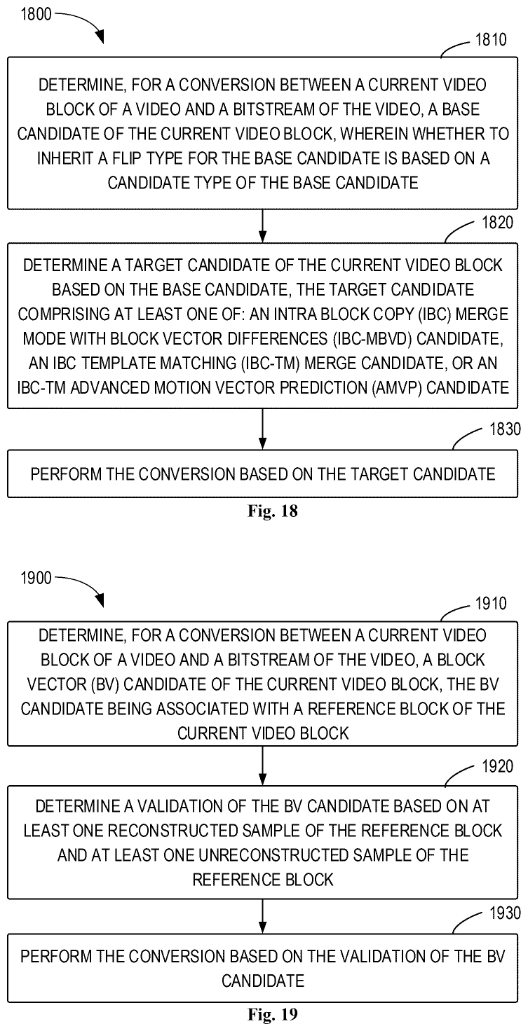

FIG. 18 illustrates a flowchart of a method 1800 for video processing in accordance with embodiments of the present disclosure. The method 3300 is implemented during a conversion between a current video block of a video and a bitstream of the video.

At block 1810, a base candidate of the current video block is determined. Whether to inherit a flip type for the base candidate is based on a candidate type of the base candidate. For example, the base candidate may be selected from a candidate list of the current video block. The candidate list may be a BV candidate list.

At block 1820, a target candidate of the current video block is determined based on the base candidate. The target candidate includes at least one of: an intra block copy (IBC) merge mode with block vector differences (IBC-MBVD) candidate, an IBC template matching (IBC-TM) merge candidate. or an IBC-TM advanced motion vector prediction (AMVP) candidate.

At block 1830, the conversion is performed based on the target candidate. In some embodiments. the conversion may include encoding the current video block into the bitstream. Alternatively, or in addition, the conversion may include decoding the current video block from the bitstream.

The method 1800 enables inheriting the flip type for the base candidate for several coding mode such as reconstruction reordered IBC (RR-IBC) mode. IBC mode or intra TMP mode, etc. In this way. the coding effectiveness and coding efficiency can be improved.

In some embodiments, the candidate type of the base candidate comprises a history-based motion vector prediction (HMVP) candidate, and the HMVP candidate inherits the flip type. That is. HMVP candidates may inherit the flip type when deriving the base candidates for IBC-MBVD or IBC-TM merge/AMVP.

In some embodiments, the base candidate comprises a BV candidate, and the target candidate is determined by applying a BV adjustment to the base candidate. For example, the target candidate may be determined by applying a BV adjustment to the base candidate to refine the base candidate. As used herein, the target candidate may be referred to as a refined base candidate. The target BV candidate may be referred to as a refined BV candidate. For example, for IBC-MBVD or IBC-TM/AMVP mode, the base candidate may be refined to obtain the target candidate.

In some embodiments, the BV adjustment comprises a flip-aware BV adjustment. That is, a flip-aware BV adjustment approach may be applied to refine the BV candidate.

In some embodiments, a flip-aware BV adjustment is not applied to refine the base candidate. That is, a flip-aware BV adjustment approach may be not applied to refine the BV candidate.

In some embodiments, whether to apply a flip-aware BV adjustment for determining the target candidate is based on a coding mode of the current video block. That is, whether to do flip-aware BV adjustment when deriving the BV candidates may depend on the coding mode.

In some embodiments, the target candidate comprises a regular IBC merge candidate, and the flip-aware BV adjustment is applied based on the flip type. For example, when deriving the regular IBC merge candidate, a flip-aware BV adjustment may be performed according to the flip type.

In some embodiments, the target candidate comprises a regular IBC AMVP candidate, and the flip-aware BV adjustment is applied based on the flip type. For example, when deriving the regular IBC AMVP candidate, a flip-aware BV adjustment may be performed according to the flip type.

In some embodiments, the target candidate comprises a regular IBC AMVP candidate, and the flip-aware BV adjustment is not applied. That is, when deriving the regular IBC AMVP candidate, a flip-aware BV adjustment may be not performed.

In some embodiments, the target candidate comprises an IBC-TM merge candidate, and the flip-aware BV adjustment is not applied.

In some embodiments, the target candidate comprises an IBC-TM AMVP candidate, and the flip-aware BV adjustment is not applied.

In some embodiments, the target candidate comprises an IBC-MBVD base merge candidate, and the flip-aware BV adjustment is not applied.

In some embodiments, the candidate type of the base candidate comprises at least one of: a spatial candidate, a temporal candidate, or a pairwise candidate, and the base candidate does not inherit the flip type. For example, spatial candidates, temporal candidates and/or pairwise candidates may not inherit the flip type when deriving the base candidates for IBC-MBVD or IBC-TM merge/AMVP.

In some embodiments, the flip type for a reconstruction-reordered IBC (RR-IBC) mode is a predefined flip type. For example, i.c., rribcFlipType is 0.

In some embodiments, the predefined flip type comprises a no flip type.

In some embodiments, the candidate type comprises a pairwise average candidate.

In some embodiments, the flip type of the pairwise average candidate is a predefined flip type. For example, the predefined flip type may be 0, which represents a no flip type.

In some embodiments, the pairwise average candidate is determined based on a first candidate and a second candidate, the first and second candidates sharing a first flip type, and the flip type of the pairwise average candidate is the first flip type.

In some embodiments, the pairwise average candidate is determined based on a first candidate and a second candidate, a first flip type of the first candidate being different from a second flip type of the second candidate, and the flip type of the pairwise average candidate is a predefined flip type. By way of example, the predefined type comprises a no flip type.

In one example, if a first candidate and a second candidate to derive a pairwise average candidate have the same flip type, set the same flip type as the flip type of the pairwise average candidate; otherwise. set 0 as the flip type of a pairwise average candidate.

In some embodiments, the pairwise average candidate is determined based on a first candidate and a second candidate, a first flip type of the first candidate being different from a second flip type of the second candidate, and the flip type of the pairwise average candidate is the first flip type.

In some embodiments, the first and second candidates are in a block vector (BV) candidate list, a first position of the first candidate in the BV candidate list is ahead of a second position of the second candidate in the BV candidate list. That is, the first candidate may be before the second candidate in the BV candidate list.

In some embodiments, the BV candidate list comprises at least one of: a regular IBC merge candidate list, a regular IBC AMVP candidate list, an IBC-TM merge candidate list, an IBC-TM AMVP candidate list, or an IBC-MBVD base merge candidate list.

According to further embodiments of the present disclosure, a non-transitory computer-readable recording medium is provided. The non-transitory computer-readable recording medium stores a bitstream of a video which is generated by a method performed by an apparatus for video processing. In the method, a base candidate of a current video block of the video is determined. Whether to inherit a flip type for the base candidate is based on a candidate type of the base candidate. A target candidate of the current video block is determined based on the base candidate. The target candidate includes at least one of: an IBC-MBVD candidate, an IBC-TM merge candidate, or an IBC-TM AMVP candidate. The bitstream is generated based on the target candidate.

According to still further embodiments of the present disclosure, a method for storing bitstream of a video is provided. In the method, a base candidate of a current video block of the video is determined. Whether to inherit a flip type for the base candidate is based on a candidate type of the base candidate. A target candidate of the current video block is determined based on the base candidate. The target candidate includes at least one of: an IBC-MBVD candidate, an IBC-TM merge candidate, or an IBC-TM AMVP candidate. The bitstream is generated based on the target candidate. The bitstream is stored in a non-transitory computer-readable recording medium.

FIG. 19 illustrates a flowchart of a method 1900 for video processing in accordance with embodiments of the present disclosure. The method 1900 is implemented for a conversion between a current video block of a video and a bitstream of the video.

At block 1910, a block vector (BV) candidate of the current video block is determined. The BV candidate is associated with a reference block of the current video block. For example, the reference block may be located based on the BV candidate. As used herein, the term “BV candidate” may also be referred to as a “BV”. In some embodiments, the BV candidate may be selected from a BV candidate list.

At block 1920, a validation of the BV candidate is determined based on at least one reconstructed sample of the reference block and at least one unreconstructed sample of the reference block. For example, whether the BV candidate is valid may be determined based on the unreconstructed samples and reconstructed samples of the reference block.

At block 1930, the conversion is performed based on the validation of the BV candidate. In some embodiments, the conversion may include encoding the current video block into the bitstream. Alternatively, or in addition, the conversion may include decoding the current video block from the bitstream. For example, if the BV candidate is valid, the conversion may be performed based on the BV candidate. If the BV candidate is invalid, the conversion may be performed without using the BV candidate.

The method 1900 determines whether the BV candidate associated with a reference block with at least one unreconstructed sample is valid based on reconstructed samples of the reference block. In this way, a reference block with is not fully reconstructed can be used in several coding modes such as an

IBC mode or an intra TMP mode. The coding effectiveness and coding efficiency can thus be improved.

In some embodiments, if a dimension of the at least one reconstructed sample of the reference block meets a condition, the validation of the BV candidate indicates that the BV candidate is valid. For example, a BV candidate may be determined to be valid when at least one sample of the reference block has not been reconstructed before the current block with dimensions BW×BH being reconstructed.

In some embodiments, the current video block is inside a current video unit. For example, the current video unit may include one of: a picture, a slice, a tile, a sub-picture, or a coding unit.

In some embodiments, a coding mode of the BV candidate comprises one of: a regular intra block copy (IBC) advanced motion vector prediction (AMVP) mode, a regular IBC merge mode, an IBC-template matching (TM) AMVP mode, an IBC-TM merge mode, an IBC merge mode with block vector differences (IBC-MBVD) mode, a reconstruction-reordered IBC (RR-IBC) AMVP mode, an RR-IBC merge mode, or an intra template matching prediction (TMP) mode.

In some embodiments, the coding mode of the BV candidate is the regular IBC AMVP mode, and the BV candidate comprises at least one of: an IBC AMVP candidate, an IBC hash-based searching point, or an IBC block matching based local searching point.

In some embodiments, the coding mode of the BV candidate is the regular IBC merge mode, and the BV candidate comprises an IBC merge candidate.

In some embodiments, the coding mode of the BV candidate is the IBC-TM AMVP mode, and the BV candidate comprises at least one of: an IBC-TM AMVP candidate, an IBC-TM AMVP refined candidate during a template matching process, an IBC hash-based searching point, or an IBC block matching based local searching point.

In some embodiments, the coding mode of the BV candidate is the IBC-TM merge mode, and the BV candidate comprises an IBC-TM merge candidate.

In some embodiments, the coding mode of the BV candidate is the IBC-MBVD mode, and the BV candidate comprises at least one of: a base BV candidate or an MBVD candidate.

In some embodiments, the MBVD candidate is determined based on the base BV candidate and a block vector difference (BVD).

In some embodiments, the coding mode of the BV candidate is the RR-IBC AMVP mode, and the BV candidate comprises at least one of: an RR-IBC AMVP candidate, an RR-IBC hash-based searching point, or an RR-IBC block matching based local searching point.

In some embodiments, the coding mode of the BV candidate is the RR-IBC merge mode, and the BV candidate comprises an RR-IBC merge candidate.

In some embodiments, the coding mode of the BV candidate is the intra TMP merge mode, and the BV candidate comprises an intra TMP searching point.

In some embodiments, the method 1900 further comprises: determining the at least one unreconstructed sample of the reference block based on at least one prediction sample of the current video block. For example, an unreconstructed sample in the reference block may be estimated using at least one prediction sample. By way of example. FIG. 14A to FIG. 14C illustrate the estimation of the unreconstructed samples in the reference block.

In some embodiments, the current video block is coded with at least one of: an IBC mode, an intra template matching prediction (TMP) mode, or a non-reconstruction-reordered IBC (non-RR-IBC) mode.

In some embodiments, a flip type of the current video block coded with the non-RR-IBC mode is a no flip type.

In some embodiments, the BV candidate satisfies at least one of: a first condition that a horizontal component of the BV candidate is smaller than or equal to a threshold value, a second condition that a vertical component of the BV candidate is smaller than or equal to a threshold value, a third condition that the horizontal component of the BV candidate is larger than a negative value of a width of a reconstructed region comprising the at least one reconstructed sample of the reference block such as (−BW), a fourth condition that the vertical component of the BV candidate is larger than a negative value of a height of the reconstructed region such as (−BH), a fifth condition that the BV candidate is a non-zero vector, or a sixth condition that a reference sample in a right-bottom position of the reference block is unreconstructed. For example, the BV candidate may satisfy one, some or all of the above conditions.

In some embodiments, the method 1800 further comprising: determining the at least one prediction sample in a first region of the current video block based on the at least one reconstructed sample of the reference block, the first region corresponding to a region of the at least one reconstructed sample of the reference block; and determining at least one remaining prediction sample in a remaining region of the current video block by: P′(x,y)=P(x+xPred, y+yPred), where P′(x,y) denotes the remaining prediction sample at a location (x,y) in the remaining region. P(x+xPred, y+yPred) denotes the prediction sample at a location (x+xPred, y+yPred), and (xPred,yPred) denotes the BV candidate of the current video block.

In some embodiments, the current video block is coded with at least one of: an intra block copy (IBC) mode, an intra template matching prediction (TMP) mode, or a non-reconstruction-reordered IBC (non-RR-IBC) mode.

In some embodiments, a flip type of the current video block coded with the non-RR-IBC mode is a no flip type. For example, rribcFlipType is 0.

In some embodiments, the method 1900 further comprises: determining the at least one unreconstructed sample of the reference block based on the at least one reconstructed sample of the reference block.

In some embodiments, the at least one unreconstructed sample of the reference block is determined by at least one of: a horizontal padding of the at least one reconstructed sample of the reference block, or a vertical padding of the at least one reconstructed sample of the reference block. For example, an unreconstructed sample in the reference block may be derived by horizontal or vertical padding, as shown in FIG. 15A to FIG. 15D.

In some embodiments, the at least one unreconstructed sample is in an unreconstructed region of the reference block, and wherein if a height of the unreconstructed region is larger than a width of the unreconstructed region, the at least one unreconstructed sample of the reference block is determined by the horizontal padding of the at least one reconstructed sample of the reference block.

In some embodiments, the at least one unreconstructed sample is in an unreconstructed region of the reference block, and wherein if a width of the unreconstructed region is larger than a height of the unreconstructed region, the at least one unreconstructed sample of the reference block is determined by the vertical padding of the at least one reconstructed sample of the reference block.

In some embodiments, if a horizontal component of the BV candidate is nonzero and a vertical component of the BV candidate is zero, the at least one unreconstructed sample of the reference block is determined by the horizontal padding of the at least one reconstructed sample of the reference block.

In some embodiments, if a horizontal component of the BV candidate is zero and a vertical component of the BV candidate is nonzero, the at least one unreconstructed sample of the reference block is determined by the vertical padding of the at least one reconstructed sample of the reference block.

In some embodiments, determining the at least one unreconstructed sample of the reference block comprises: determining a boundary of a first sub-region and a second sub-region of an unreconstructed region of the reference block based on the BV candidate, the at least one unreconstructed sample comprising a first set of unreconstructed samples in the first sub-region and a second set of unreconstructed samples in the second sub-region; determining the first set of unreconstructed samples by a horizontal padding of the at least one reconstructed sample: and determining the second set of unreconstructed samples by a vertical padding of the at least one reconstructed sample.

In some embodiments, the unreconstructed region of the reference block comprises an overlapped region between the reference block and the current video block, and the boundary is determined by extending the BV candidate along the overlapped region.

In some embodiments, the first sub-region comprises a bottom-left sub-region, and the first set of unreconstructed samples is determined by horizontal padding at least one constructed reference sample in a right-most column of a coding unit left to the current video block.

In some embodiments, the second sub-region comprises a top-right sub-region, and the second set of unreconstructed samples is determined by vertical padding at least one constructed reference sample in a bottom-most row of a coding unit above to the current video block.

By way of example, as shown in FIG. 15D, the BV of current block ix extended along the same line towards the overlapped area to split the overlapped area into two regions. The reference samples in the bottom-left overlapped region are generated by copying the reference samples of the right-most column of the left CU (horizontal padding), and the reference samples in the top-right region are generated by copying the reference samples of the bottom-most row of the above CU (vertical padding).

In some embodiments, the current video block is coded with at least one of: an IBC mode, an intra TMP mode, or an RR-IBC mode.

In some embodiments, a flip type of the current video block coded with the RR-IBC mode comprises a first flip type or a second flip type. For example, rribcFlipType is 1 or 2.

In some embodiments, a first template matching process for the BV candidate is different from a second template matching process for a further BV candidate, the BV candidate being associated with the reference block comprising the at least one reconstructed sample and the at least one unreconstructed sample, the further BV candidate being associated with a further reference block fully reconstructed inside a current picture.

In some embodiments, the first template matching process comprises a template matching based reordering process. Alternatively, or in addition, in some embodiments, the first template matching process comprises a template matching based refinement process.

In some embodiments, if a reference sample of a reference template of the current video block is unreconstructed, a reference sample of a current template of the current video block corresponding to the reference sample of the reference block is padded.

In some embodiments, padding of the reference sample of the current template to the reference sample of the reference template is same with padding of a reference sample in a reconstructed region of the reference block to a reference sample in an unreconstructed region of the reference block.

In some embodiments, if the current video block is horizontally flipped, the reference sample of the current template is to be padded to the reference sample of the reference template.

In some embodiments, a right column part of the reference template is determined based on at least one of: a horizontal padding of the current template, or at least one prediction sample of the current video block. For example, FIG. 16 illustrates the horizontal padding of the current template to the reference samples of the reference template.

In some embodiments, if the current video block is vertically flipped, the reference sample of the current template is to be padded to the reference sample of the reference template.

In some embodiments, a bottom row part of the reference template is determined based on at least one of: a vertical padding of the current template, or at least one prediction sample of the current video block. For example, FIG. 17 illustrates the vertical padding of the current template to the reference samples of the reference template.

In some embodiments, during the first template matching process, a first template matching cost of the BV candidate between a current template and a reference template of the current video block is adjusted.

In some embodiments, the first template matching cost is multiplied by a factor.

In some embodiments, the factor is larger than 1. By way of example, the factor may be 2.5, 3 or 3.5.

In some embodiments, the factor is an integer.

In some embodiments, the factor is associated with an overlapping ratio of an unreconstructed region of the reference block to an area of the current video block.

In some embodiments, a first factor associated with a first overlapping ratio is larger than a second factor associated with a second overlapping ratio less than the first overlapping ratio.

In some embodiments, a first overlapping ratio of a first reference block associated with a first BV candidate of the current video block is larger than or equal to a second overlapping ratio of a second reference block associated with a second BV candidate of the current video block, and a first factor associated with the first BV candidate is larger than or equal to a second factor associated with the second BV candidate.

In some embodiments, the factor is different for different coding configurations.

In some embodiments, the factor is different for different sequence resolutions.

In some embodiments, the first template matching cost is adjusted by a metric, the metric comprising one of: C′=a*C+RightShift(C, b), or C′=a*C, wherein C denotes the first template matching cost. C′ denotes the adjusted first template matching cost, a denotes a factor, RightShift(C, b) represents an operation of right shift an representation of C by b, b being an integer.

In some embodiments, the factor “a” may be 3, 2, 4, or 1. In some embodiments, the factor “b” may be 1. That is, the metric may be one of: C′=3*C+RightShift(C,1), C′=2*C+RightShift(C,1). C′=4*C+RightShift(C,1). C′=1*C+RightShift(C,1), C′=3*C, C′=2*C, or C′=4*C. It is to be understood that these metrics are only for the purpose of illustration, without suggesting any limitation. Any suitable metric or function may be used to adjust the first template matching cost. Scope of the present disclosure is not limited here.

In some embodiments, the current video block or a video unit comprises one of: a color component. a sub-picture, a slice, a tile, a coding tree unit (CTU), a CTU row, groups of CTUs a coding unit (CU), a prediction unit (PU), a transform unit (TU), a coding tree block (CTB), a coding block (CB), a prediction block (PB), a transform block (TB), a block, a sub-block of a block, a sub-region within a block, or a region that contains more than one sample or pixel.

According to further embodiments of the present disclosure, a non-transitory computer-readable recording medium is provided. The non-transitory computer-readable recording medium stores a bitstream of a video which is generated by a method performed by an apparatus for video processing. In the method, a BV candidate of a current video block of the video is determined. The BV candidate is associated with a reference block of the current video block. A validation of the BV candidate is determined based on at least one reconstructed sample of the reference block and at least one unreconstructed sample of the reference block. The bitstream is generated based on the validation of the BV candidate.

According to still further embodiments of the present disclosure, a method for storing bitstream of a video is provided. In the method, a BV candidate of a current video block of the video is determined. The BV candidate is associated with a reference block of the current video block. A validation of the BV candidate is determined based on at least one reconstructed sample of the reference block and at least one unreconstructed sample of the reference block. The bitstream is generated based on the validation of the BV candidate. The bitstream is stored in a non-transitory computer-readable recording medium.

In some embodiments, information regarding whether to and/or how to apply the method 1800 and/or the method 1900 is included in the bitstream.

In some embodiments, the information is indicated at one of: a sequence level, a group of pictures level, a picture level, a slice level or a tile group level.

In some embodiments, the information is indicated in a sequence header, a picture header, a sequence parameter set (SPS), a Video Parameter Set (VPS), a decoded parameter set (DPS). Decoding Capability Information (DCI), a Picture Parameter Set (PPS), an Adaptation Parameter Set (APS), a slice header or a tile group header.

In some embodiments, the information is indicated in a region containing more than one sample or pixel.

In some embodiments, the region comprising one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

In some embodiments, the information is based on coded information.

In some embodiments, the coded information comprises at least one of: a coding mode, a block size, a color format, a single or dual tree partitioning, a color component, a slice type, or a picture type.

It is to be understood that the method 1800 and/or the method 1900 can be applied separately, or in any combination. With the method 1800 and/or the method 1900, the coding effectiveness and/or the coding efficiency can be improved.

Implementations of the present disclosure can be described in view of the following clauses, the features of which can be combined in any reasonable manner.

Clause 1. A method for video processing, comprising: determining, for a conversion between a current video block of a video and a bitstream of the video, a base candidate of the current video block, wherein whether to inherit a flip type for the base candidate is based on a candidate type of the base candidate; determining a target candidate of the current video block based on the base candidate, the target candidate comprising at least one of: an intra block copy (IBC) merge mode with block vector differences (IBC-MBVD) candidate, an IBC template matching (IBC-TM) merge candidate, or an IBC-TM advanced motion vector prediction (AMVP) candidate; and performing the conversion based on the target candidate.

Clause 2. The method of clause 1, wherein the candidate type of the base candidate comprises a history-based motion vector prediction (HMVP) candidate, and the HMVP candidate inherits the flip type.

Clause 3. The method of clause 1 or clause 2, wherein the base candidate comprises a block vector (BV) candidate, and the target candidate is determined by applying a BV adjustment to the base candidate.

Clause 4. The method of clause 3, wherein the BV adjustment comprises a flip-aware BV adjustment.

Clause 5. The method of clause 3, wherein a flip-aware BV adjustment is not applied to refine the base candidate.

Clause 6. The method of clause 3, wherein whether to apply a flip-aware BV adjustment for determining the target candidate is based on a coding mode of the current video block.

Clause 7. The method of clause 6, wherein the target candidate comprises a regular IBC merge candidate, and the flip-aware BV adjustment is applied based on the flip type.

Clause 8. The method of clause 6, wherein the target candidate comprises a regular IBC AMVP candidate, and the flip-aware BV adjustment is applied based on the flip type.

Clause 9. The method of clause 6, wherein the target candidate comprises a regular IBC AMVP candidate, and the flip-aware BV adjustment is not applied.

Clause 10. The method of clause 6, wherein the target candidate comprises an IBC-TM merge candidate, and the flip-aware BV adjustment is not applied.

Clause 11. The method of clause 6, wherein the target candidate comprises an IBC-TM AMVP candidate, and the flip-aware BV adjustment is not applied.

Clause 12. The method of clause 6, wherein the target candidate comprises an IBC-MBVD base merge candidate, and the flip-aware BV adjustment is not applied.

Clause 13. The method of any of clauses 1-12, wherein the candidate type of the base candidate comprises at least one of: a spatial candidate, a temporal candidate, or a pairwise candidate, and the base candidate does not inherit the flip type.

Clause 14. The method of clause 13, wherein the flip type for a reconstruction-reordered IBC (RR- IBC) mode is a predefined flip type.

Clause 15. The method of clause 14, wherein the predefined flip type comprises a no flip type.

Clause 16. The method of any of clauses 1-15, wherein the candidate type comprises a pairwise average candidate.

Clause 17. The method of clause 16, wherein the flip type of the pairwise average candidate is a predefined flip type.

Clause 18. The method of clause 16, wherein the pairwise average candidate is determined based on a first candidate and a second candidate, the first and second candidates sharing a first flip type, and the flip type of the pairwise average candidate is the first flip type.

Clause 19, method of clause 16, wherein the pairwise average candidate is determined based on a first candidate and a second candidate, a first flip type of the first candidate being different from a second flip type of the second candidate, and the flip type of the pairwise average candidate is a predefined flip type.

Clause 20. The method of clause 17 or clause 19, wherein the predefined type comprises a no flip type.

Clause 21. The method of clause 16, wherein the pairwise average candidate is determined based on a first candidate and a second candidate, a first flip type of the first candidate being different from a second flip type of the second candidate, and the flip type of the pairwise average candidate is the first flip type.

Clause 22. The method of clause 21, wherein the first and second candidates are in a block vector (BV) candidate list, a first position of the first candidate in the BV candidate list is ahead of a second position of the second candidate in the BV candidate list.

Clause 23. The method of clause 21 or 22, wherein the BV candidate list comprises at least one of: a regular IBC merge candidate list, a regular IBC AMVP candidate list, an IBC-TM merge candidate list, an IBC-TM AMVP candidate list, or an IBC-MBVD base merge candidate list.

Clause 24. A method for video processing, comprising: determining, for a conversion between a current video block of a video and a bitstream of the video, a block vector (BV) candidate of the current video block, the BV candidate being associated with a reference block of the current video block; determining a validation of the BV candidate based on at least one reconstructed sample of the reference block and at least one unreconstructed sample of the reference block; and performing the conversion based on the validation of the BV candidate.

Clause 25. The method of clause 24, wherein if a dimension of the at least one reconstructed sample of the reference block meets a condition, the validation of the BV candidate indicates that the BV candidate is valid.

Clause 26. The method of clause 24 or clause 25, wherein the current video block is inside a current video unit, the current video unit comprising one of: a picture, a slice, a tile, a sub-picture, or a coding unit.

Clause 27. The method of any of clauses 24-26, wherein a coding mode of the BV candidate comprises one of: a regular intra block copy (IBC) advanced motion vector prediction (AMVP) mode, a regular IBC merge mode, an IBC-template matching (TM) AMVP mode, an IBC-TM merge mode, an

IBC merge mode with block vector differences (IBC-MBVD) mode, a reconstruction-reordered IBC (RR-IBC) AMVP mode, an RR-IBC merge mode, or an intra template matching prediction (TMP) mode.

Clause 28. The method of clause 27, wherein the coding mode of the BV candidate is the regular IBC AMVP mode, and the BV candidate comprises at least one of: an IBC AMVP candidate, an IBC hash-based searching point, or an IBC block matching based local searching point.

Clause 29. The method of clause 27, wherein the coding mode of the BV candidate is the regular IBC merge mode, and the BV candidate comprises an IBC merge candidate.

Clause 30. The method of clause 27, wherein the coding mode of the BV candidate is the IBC-TM AMVP mode, and the BV candidate comprises at least one of: an IBC-TM AMVP candidate, an IBC-TM AMVP refined candidate during a template matching process, an IBC hash-based searching point, or an IBC block matching based local searching point.

Clause 31. The method of clause 27, wherein the coding mode of the BV candidate is the IBC-TM merge mode, and the BV candidate comprises an IBC-TM merge candidate.

Clause 32. The method of clause 27, wherein the coding mode of the BV candidate is the IBC-MBVD mode, and the BV candidate comprises at least one of: a base BV candidate or an MBVD candidate.

Clause 33. The method of clause 32, wherein the MBVD candidate is determined based on the base BV candidate and a block vector difference (BVD).

Clause 34. The method of clause 27, wherein the coding mode of the BV candidate is the RR-IBC AMVP mode, and the BV candidate comprises at least one of: an RR-IBC AMVP candidate, an RR-IBC hash-based searching point, or an RR-IBC block matching based local searching point.

Clause 35. The method of clause 27, wherein the coding mode of the BV candidate is the RR-IBC merge mode, and the BV candidate comprises an RR-IBC merge candidate.

Clause 36. The method of clause 27, wherein the coding mode of the BV candidate is the intra TMP merge mode, and the BV candidate comprises an intra TMP searching point.

Clause 37. The method of any of clauses 24-36, further comprising: determining the at least one unreconstructed sample of the reference block based on at least one prediction sample of the current video block.

Clause 38. The method of clause 37, wherein the current video block is coded with at least one of: an intra block copy (IBC) mode, an intra template matching prediction (TMP) mode, or a non-reconstruction-reordered IBC (non-RR-IBC) mode.

Clause 39. The method of clause 38, wherein a flip type of the current video block coded with the non-RR-IBC mode is a no flip type.

Clause 40. The method of any of clauses 37-39, wherein the BV candidate satisfies at least one of: a first condition that a horizontal component of the BV candidate is smaller than or equal to a threshold value, a second condition that a vertical component of the BV candidate is smaller than or equal to a threshold value, a third condition that the horizontal component of the BV candidate is larger than a negative value of a width of a reconstructed region comprising the at least one reconstructed sample of the reference block, a fourth condition that the vertical component of the BV candidate is larger than a negative value of a height of the reconstructed region, a fifth condition that the BV candidate is a non-zero vector, or a sixth condition that a reference sample in a right-bottom position of the reference block is unreconstructed.

Clause 41. The method of any of clauses 37-40, further comprising: determining the at least one prediction sample in a first region of the current video block based on the at least one reconstructed sample of the reference block, the first region corresponding to a region of the at least one reconstructed sample of the reference block; and determining at least one remaining prediction sample in a remaining region of the current video block by using: P′(x,y)=P(x+xPred, y+yPred), wherein P′(x,y) denotes the remaining prediction sample at a location (x, y) in the remaining region. P(x+xPred, y+yPred) denotes the prediction sample at a location (x+xPred, y+yPred), and (xPred,yPred) denotes the BV candidate of the current video block.

Clause 42. The method of clause 41, wherein the current video block is coded with at least one of: an intra block copy (IBC) mode, an intra template matching prediction (TMP) mode, or a non-reconstruction-reordered IBC (non-RR-IBC) mode.

Clause 43. The method of clause 42, wherein a flip type of the current video block coded with the non-RR-IBC mode is a no flip type.

Clause 44. The method of any of clauses 24-36, further comprising: determining the at least one unreconstructed sample of the reference block based on the at least one reconstructed sample of the reference block.

Clause 45. The method of clause 44, wherein the at least one unreconstructed sample of the reference block is determined by at least one of: a horizontal padding of the at least one reconstructed sample of the reference block, or a vertical padding of the at least one reconstructed sample of the reference block.

Clause 46. The method of clause 45, wherein the at least one unreconstructed sample is in an unreconstructed region of the reference block, and wherein if a height of the unreconstructed region is larger than a width of the unreconstructed region, the at least one unreconstructed sample of the reference block is determined by the horizontal padding of the at least one reconstructed sample of the reference block.

Clause 47. The method of clause 45, wherein the at least one unreconstructed sample is in an unreconstructed region of the reference block, and wherein if a width of the unreconstructed region is larger than a height of the unreconstructed region, the at least one unreconstructed sample of the reference block is determined by the vertical padding of the at least one reconstructed sample of the reference block.

Clause 48. The method of clause 45, wherein if a horizontal component of the BV candidate is nonzero and a vertical component of the BV candidate is zero, the at least one unreconstructed sample of the reference block is determined by the horizontal padding of the at least one reconstructed sample of the reference block.

Clause 49. The method of clause 45, wherein if a horizontal component of the BV candidate is zero and a vertical component of the BV candidate is nonzero, the at least one unreconstructed sample of the reference block is determined by the vertical padding of the at least one reconstructed sample of the reference block.

Clause 50. The method of clause 44, wherein determining the at least one unreconstructed sample of the reference block comprises: determining a boundary of a first sub-region and a second sub-region of an unreconstructed region of the reference block based on the BV candidate, the at least one unreconstructed sample comprising a first set of unreconstructed samples in the first sub-region and a second set of unreconstructed samples in the second sub-region; determining the first set of unreconstructed samples by a horizontal padding of the at least one reconstructed sample; and determining the second set of unreconstructed samples by a vertical padding of the at least one reconstructed sample.

Clause 51. The method of clause 50, wherein the unreconstructed region of the reference block comprises an overlapped region between the reference block and the current video block, and the boundary is determined by extending the BV candidate along the overlapped region.

Clause 52. The method of clause 50 or 51, wherein the first sub-region comprises a bottom-left sub-region, and the first set of unreconstructed samples is determined by horizontal padding at least one constructed reference sample in a right-most column of a coding unit left to the current video block.

Clause 53. The method of any of clauses 50-52, wherein the second sub-region comprises a top-right sub-region, and the second set of unreconstructed samples is determined by vertical padding at least one constructed reference sample in a bottom-most row of a coding unit above to the current video block.

Clause 54. The method of any of clauses 44-53, wherein the current video block is coded with at least one of: an intra block copy (IBC) mode, an intra template matching prediction (TMP) mode, or a reconstruction-reordered IBC (RR-IBC) mode.

Clause 55. The method of clause 54, wherein a flip type of the current video block coded with the RR-IBC mode comprises a first flip type or a second flip type.

Clause 56. The method of any of clauses 24-55, wherein a first template matching process for the BV candidate is different from a second template matching process for a further BV candidate, the BV candidate being associated with the reference block comprising the at least one reconstructed sample and the at least one unreconstructed sample, the further BV candidate being associated with a further reference block fully reconstructed inside a current picture.

Clause 57. The method of clause 56, wherein the first template matching process comprises a template matching based reordering process.

Clause 58. The method of clause 56, wherein the first template matching process comprises a template matching based refinement process.

Clause 59. The method of any of clauses 56-58, wherein if a reference sample of a reference template of the current video block is unreconstructed, a reference sample of a current template of the current video block corresponding to the reference sample of the reference block is padded.

Clause 60. The method of clause 59, wherein padding of the reference sample of the current template to the reference sample of the reference template is same with padding of a reference sample in a reconstructed region of the reference block to a reference sample in an unreconstructed region of the reference block.

Clause 61. The method of clause 59 or 60, wherein if the current video block is horizontally flipped. the reference sample of the current template is to be padded to the reference sample of the reference template.

Clause 62. The method of clause 61, wherein a right column part of the reference template is determined based on at least one of: a horizontal padding of the current template, or at least one prediction sample of the current video block.

Clause 63. The method of clause 59 or 60, wherein if the current video block is vertically flipped, the reference sample of the current template is to be padded to the reference sample of the reference template.

Clause 64. The method of clause 63, wherein a bottom row part of the reference template is determined based on at least one of: a vertical padding of the current template, or at least one prediction sample of the current video block.

Clause 65. The method of any of clauses 56-64, wherein during the first template matching process, a first template matching cost of the BV candidate between a current template and a reference template of the current video block is adjusted.

Clause 66. The method of clause 65, wherein the first template matching cost is multiplied by a factor.

Clause 67. The method of clause 66, wherein the factor is larger than 1.

Clause 68. The method of clause 66 or 67, wherein the factor is an integer.

Clause 69. The method of clause 66 or 67, wherein the factor comprises one of: 2.5, 3 or 3.5.

Clause 70. The method of any of clauses 66-69, wherein the factor is associated with an overlapping ratio of an unreconstructed region of the reference block to an area of the current video block.

Clause 71. The method of clause 70, wherein a first factor associated with a first overlapping ratio is larger than a second factor associated with a second overlapping ratio less than the first overlapping ratio.

Clause 72. The method of clause 70, wherein a first overlapping ratio of a first reference block associated with a first BV candidate of the current video block is larger than or equal to a second overlapping ratio of a second reference block associated with a second BV candidate of the current video block, and a first factor associated with the first BV candidate is larger than or equal to a second factor associated with the second BV candidate.

Clause 73. The method of any of clauses 66-72, wherein the factor is different for different coding configurations.

Clause 74. The method of any of clauses 66-73, wherein the factor is different for different sequence resolutions.

Clause 75. The method of clause 65, wherein the first template matching cost is adjusted by a metric, the metric comprising one of: C′=a*C+RightShift(C, b), or C′=a*C, wherein C denotes the first template matching cost. C′ denotes the adjusted first template matching cost, a denotes a factor, RightShift(C, b) represents an operation of right shift an representation of C by b, b being an integer.

Clause 76. The method of clause 75, wherein the factor a comprises one of: 3, 2, 4, or 1.

Clause 77. The method of clause 75, wherein the factor b comprises 1.

Clause 78. The method of any of clauses 1-77, wherein the current video block or a video unit comprises one of: a color component, a sub-picture, a slice, a tile, a coding tree unit (CTU), a CTU row, groups of CTUs a coding unit (CU), a prediction unit (PU), a transform unit (TU), a coding tree block (CTB), a coding block (CB), a prediction block (PB), a transform block (TB), a block, a sub-block of a block, a sub-region within a block, or a region that contains more than one sample or pixel.

Clause 79. The method of any of clauses 1-78, wherein information regarding whether to and/or how to apply the method is included in the bitstream.

Clause 80. The method of clause 79, wherein the information is indicated at one of: a sequence level, a group of pictures level, a picture level, a slice level or a tile group level.

Clause 81. The method of clause 79 or clause 80, wherein the information is indicated in a sequence header, a picture header, a sequence parameter set (SPS), a Video Parameter Set (VPS), a decoded parameter set (DPS). Decoding Capability Information (DCI), a Picture Parameter Set (PPS), an Adaptation Parameter Set (APS), a slice header or a tile group header.

Clause 82. The method of any of clauses 79-81, wherein the information is indicated in a region containing more than one sample or pixel.

Clause 83. The method of clause 82, wherein the region comprising one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

Clause 84. The method of any of clauses 79-83, wherein the information is based on coded information.

Clause 85. The method of clause 84, wherein the coded information comprises at least one of: a coding mode, a block size, a color format, a single or dual tree partitioning, a color component, a slice type, or a picture type.

Clause 86. The method of any of clauses 1-85, wherein the conversion includes encoding the current video block into the bitstream.

Clause 87. The method of any of clauses 1-85, wherein the conversion includes decoding the current video block from the bitstream.

Clause 88. An apparatus for video processing comprising a processor and a non-transitory memory with instructions thereon, wherein the instructions upon execution by the processor, cause the processor to perform a method in accordance with any of clauses 1-87.

Clause 89. A non-transitory computer-readable storage medium storing instructions that cause a processor to perform a method in accordance with any of clauses 1-87.

Clause 90. A non-transitory computer-readable recording medium storing a bitstream of a video which is generated by a method performed by an apparatus for video processing, wherein the method comprises: determining a base candidate of a current video block of the video, wherein whether to inherit a flip type for the base candidate is based on a candidate type of the base candidate; determining a target candidate of the current video block based on the base candidate, the target candidate comprising at least one of: an intra block copy (IBC) merge mode with block vector differences (IBC-MBVD) candidate, an IBC template matching (IBC-TM) merge candidate, or an IBC-TM advanced motion vector prediction (AMVP) candidate; and generating the bitstream based on the target candidate.

Clause 91. A method for storing a bitstream of a video, comprising: determining a base candidate of a current video block of the video, wherein whether to inherit a flip type for the base candidate is based on a candidate type of the base candidate; determining a target candidate of the current video block based on the base candidate, the target candidate comprising at least one of: an intra block copy (IBC) merge mode with block vector differences (IBC-MBVD) candidate, an IBC template matching (IBC-TM) merge candidate, or an IBC-TM advanced motion vector prediction (AMVP) candidate; generating the bitstream based on the target candidate; and storing the bitstream in a non-transitory computer-readable recording medium.

Clause 92. A non-transitory computer-readable recording medium storing a bitstream of a video which is generated by a method performed by an apparatus for video processing, wherein the method comprises: determining a block vector (BV) candidate of a current video block of the video, the BV candidate being associated with a reference block of the current video block; determining a validation of the BV candidate based on at least one reconstructed sample of the reference block and at least one unreconstructed sample of the reference block; and generating the bitstream based on the validation of the BV candidate.

Clause 93. A method for storing a bitstream of a video, comprising: determining a block vector (BV) candidate of a current video block of the video, the BV candidate being associated with a reference block of the current video block; determining a validation of the BV candidate based on at least one reconstructed sample of the reference block and at least one unreconstructed sample of the reference block; generating the bitstream based on the validation of the BV candidate; and storing the bitstream in a non-transitory computer-readable recording medium.

### EXAMPLE DEVICE

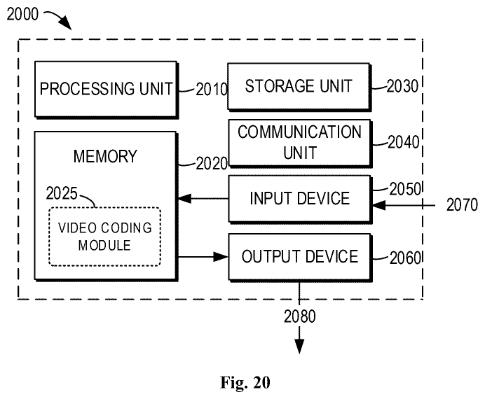

FIG. 20 illustrates a block diagram of a computing device 2000 in which various embodiments of the present disclosure can be implemented. The computing device 2000 may be implemented as or included in the source device 110 (or the video encoder 114 or 200) or the destination device 120 (or the video decoder 124 or 300).

It would be appreciated that the computing device 2000 shown in FIG. 20 is merely for purpose of illustration, without suggesting any limitation to the functions and scopes of the embodiments of the present disclosure in any manner.

As shown in FIG. 20, the computing device 2000 includes a general-purpose computing device 2000. The computing device 2000 may at least comprise one or more processors or processing units 2010. a memory 2020, a storage unit 2030, one or more communication units 2040, one or more input devices 2050, and one or more output devices 2060.

In some embodiments, the computing device 2000 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station. unit, device, multimedia computer, multimedia tablet. Internet node, communicator, desktop computer, laptop computer. notebook computer, netbook computer, tablet computer, personal communication system (PCS) device, personal navigation device, personal digital assistant (PDA), audio/video player. digital camera/video camera, positioning device, television receiver, radio broadcast receiver. E-book device, gaming device, or any combination thereof, including the accessories and peripherals of these devices, or any combination thereof. It would be contemplated that the computing device 2000 can support any type of interface to a user (such as “wearable” circuitry and the like).

The processing unit 2010 may be a physical or virtual processor and can implement various processes based on programs stored in the memory 2020. In a multi-processor system, multiple processing units execute computer executable instructions in parallel so as to improve the parallel processing capability of the computing device 2000. The processing unit 2010 may also be referred to as a central processing unit (CPU), a microprocessor, a controller or a microcontroller.

The computing device 2000 typically includes various computer storage medium. Such medium can be any medium accessible by the computing device 2000, including, but not limited to. volatile and non-volatile medium, or detachable and non-detachable medium. The memory 2020 can be a volatile memory (for example, a register, cache. Random Access Memory (RAM)), a non-volatile memory (such as a Read-Only Memory (ROM). Electrically Erasable Programmable Read-Only Memory (EEPROM). or a flash memory), or any combination thereof. The storage unit 2030 may be any detachable or non-detachable medium and may include a machine-readable medium such as a memory, flash memory drive. magnetic disk or another other media, which can be used for storing information and/or data and can be accessed in the computing device 2000.

The computing device 2000 may further include additional detachable/non-detachable. volatile/non-volatile memory medium. Although not shown in FIG. 20, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2040 communicates with a further computing device via the communication medium. In addition, the functions of the components in the computing device 2000 can be implemented by a single computing cluster or multiple computing machines that can communicate via communication connections. Therefore, the computing device 2000 can operate in a networked environment using a logical connection with one or more other servers. networked personal computers (PCs) or further general network nodes.

The input device 2050 may be one or more of a variety of input devices, such as a mouse. keyboard. tracking ball. voice-input device, and the like. The output device 2060 may be one or more of a variety of output devices, such as a display. loudspeaker, printer, and the like. By means of the communication unit 2040, the computing device 2000 can further communicate with one or more external devices (not shown) such as the storage devices and display device, with one or more devices enabling the user to interact with the computing device 2000, or any devices (such as a network card, a modem and the like) enabling the computing device 2000 to communicate with one or more other computing devices, if required. Such communication can be performed via input/output (I/O) interfaces (not shown).

In some embodiments, instead of being integrated in a single device, some or all components of the computing device 2000 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2000 may be used to implement video encoding/decoding in embodiments of the present disclosure. The memory 2020 may include one or more video coding modules 2025 having one or more program instructions. These modules are accessible and executable by the processing unit 2010 to perform the functionalities of the various embodiments described herein.

In the example embodiments of performing video encoding, the input device 2050 may receive video data as an input 2070 to be encoded. The video data may be processed, for example, by the video coding module 2025, to generate an encoded bitstream. The encoded bitstream may be provided via the output device 2060 as an output 2080.

In the example embodiments of performing video decoding, the input device 2050 may receive an encoded bitstream as the input 2070. The encoded bitstream may be processed, for example, by the video coding module 2025, to generate decoded video data. The decoded video data may be provided via the output device 2060 as the output 2080.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for video processing, comprising:
determining, for a conversion between a current video block of a video and a bitstream of the video, a base candidate of the current video block, wherein whether to inherit a flip type for the base candidate is based on a candidate type of the base candidate;
determining a target candidate of the current video block based on the base candidate, the target candidate comprising at least one of: an intra block copy (IBC) merge mode with block vector differences (IBC-MBVD) candidate, an IBC template matching (IBC-TM) merge candidate, or an IBC-TM advanced motion vector prediction (AMVP) candidate; and
performing the conversion based on the target candidate.

2. The method of claim 1, wherein the candidate type of the base candidate comprises a history-based motion vector prediction (HMVP) candidate, and the HMVP candidate inherits the flip type.

3. The method of claim 1, wherein the base candidate comprises a block vector (BV) candidate, and the target candidate is determined by applying a BV adjustment to the base candidate.

4. The method of claim 3, wherein the BV adjustment comprises a flip-aware BV adjustment, or wherein a flip-aware BV adjustment is not applied to refine the base candidate.

5. The method of claim 3, wherein whether to apply a flip-aware BV adjustment for determining the target candidate is based on a coding mode of the current video block.

6. The method of claim 5, wherein the target candidate comprises a regular IBC merge candidate, and the flip-aware BV adjustment is applied based on the flip type, or
wherein the target candidate comprises a regular IBC AMVP candidate, and the flip-aware BV adjustment is applied based on the flip type, or
wherein the target candidate comprises a regular IBC AMVP candidate, and the flip-aware BV adjustment is not applied, or
wherein the target candidate comprises an IBC-TM merge candidate, and the flip-aware BV adjustment is not applied, or
wherein the target candidate comprises an IBC-TM AMVP candidate, and the flip-aware BV adjustment is not applied, or
wherein the target candidate comprises an IBC-MBVD base merge candidate, and the flip-aware BV adjustment is not applied.

7. The method of claim 1, wherein the candidate type of the base candidate comprises at least one of: a spatial candidate, a temporal candidate, or a pairwise candidate, and the base candidate does not inherit the flip type.

8. The method of claim 7, wherein the flip type for a reconstruction-reordered IBC (RR-IBC) mode is a predefined flip type,
wherein the predefined flip type comprises a no flip type.

9. The method of claim 1, wherein the candidate type comprises a pairwise average candidate.

10. The method of claim 9, wherein the flip type of the pairwise average candidate is a predefined flip type, wherein the predefined type comprises a no flip type.

11. The method of claim 9, wherein the pairwise average candidate is determined based on a first candidate and a second candidate, the first and second candidates sharing a first flip type, and the flip type of the pairwise average candidate is the first flip type.

12. The method of claim 9, wherein the pairwise average candidate is determined based on a first candidate and a second candidate, a first flip type of the first candidate being different from a second flip type of the second candidate, and the flip type of the pairwise average candidate is a predefined flip type, wherein the predefined type comprises a no flip type.

13. The method of claim 9, wherein the pairwise average candidate is determined based on a first candidate and a second candidate, a first flip type of the first candidate being different from a second flip type of the second candidate, and the flip type of the pairwise average candidate is the first flip type.

14. The method of claim 13, wherein the first and second candidates are in a block vector (BV) candidate list, a first position of the first candidate in the BV candidate list is ahead of a second position of the second candidate in the BV candidate list.

15. The method of claim 13, wherein the BV candidate list comprises at least one of:
a regular IBC merge candidate list,
a regular IBC AMVP candidate list,
an IBC-TM merge candidate list,
an IBC-TM AMVP candidate list, or
an IBC-MBVD base merge candidate list.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, a base candidate of the current video block, wherein whether to inherit a flip type for the base candidate is based on a candidate type of the base candidate;
determine a target candidate of the current video block based on the base candidate, the target candidate comprising at least one of: an intra block copy (IBC) merge mode with block vector differences (IBC-MBVD) candidate, an IBC template matching (IBC-TM) merge candidate, or an IBC-TM advanced motion vector prediction (AMVP) candidate; and
perform the conversion based on the target candidate.

19. A non-transitory computer-readable storage medium storing instructions that cause a processor to perform a method comprising:
determining, for a conversion between a current video block of a video and a bitstream of the video, a base candidate of the current video block, wherein whether to inherit a flip type for the base candidate is based on a candidate type of the base candidate;
determining a target candidate of the current video block based on the base candidate, the target candidate comprising at least one of: an intra block copy (IBC) merge mode with block vector differences (IBC-MBVD) candidate, an IBC template matching (IBC-TM) merge candidate, or an IBC-TM advanced motion vector prediction (AMVP) candidate; and
performing the conversion based on the target candidate.

20. A non-transitory computer-readable recording medium storing a bitstream of a video which is generated by a method performed by an apparatus for video processing, wherein the method comprises:
determining a base candidate of a current video block of the video, wherein whether to inherit a flip type for the base candidate is based on a candidate type of the base candidate;
determining a target candidate of the current video block based on the base candidate, the target candidate comprising at least one of: an intra block copy (IBC) merge mode with block vector differences (IBC-MBVD) candidate, an IBC template matching (IBC-TM) merge candidate, or an IBC-TM advanced motion vector prediction (AMVP) candidate; and
generating the bitstream based on the target candidate.
